(19) United States
(12) Patent Application Publication
(10) Pub. No.: US 2026/0251191 A1
(43) Pub. Date: Aug. 27, 2026

(54) DISC BRAKE

(71) Applicant: ASTEMO, LTD., Tokyo (JP)

(72) Inventors: Miyuki UNO, Hitachinaka-shi (JP); Shinji SUZUKI, Hitachinaka-shi (JP)

(21) Appl. No.: 19/160,083

(22) PCT Filed: Feb. 8, 2024
(86) PCT No.: PCT/JP2024/004319

§ 371 Date: Aug. 27, 2025

(30) Foreign Application Priority Data
Mar. 3, 2023 (JP) 2023-032660

(51) Int. Cl. F16D 65/00

(52) U.S. Cl. CPC F16D 65/0068; F16D 65/0081

(57) ABSTRACT

This disc brake includes a caliper (13) movably provided in an attachment member and pressing a brake pad (18) against a disc. The caliper (13) has a plurality of claws (71) disposed in a manner of facing a cylinder portion (55), and a recessed portion (81) provided between the plurality of claws (71), having an opening portion (82) at an inner end in a radial direction with respect to a rotation axis of the disc, and formed in a manner of opposing a cylinder hole (61) of the cylinder portion (55); and has a cover member fixing hole (98) formed in an inner circumference of the recessed portion (81) in a manner of being inclined with respect to the radial direction with respect to the rotation axis of the disc.

Priority is claimed on Japanese Patent Application No. 2023-032660, filed Mar. 3, 2023, the content of which is incorporated herein by reference.

### TECHNICAL FIELD

The present invention relates to a disc brake.

### BACKGROUND ART

A disc brake equipped with a cover member in a part of a caliper which can be seen when viewed from outside a vehicle is known (for example, refer to Patent Document 1).

### CITATION LIST

### Patent Document

Patent Document 1: Specification of United States Patent Application, Publication No. 2019/0063522

### SUMMARY OF INVENTION

### Technical Problem

It is desired that removal of a cover member from a disc brake in a state of being attached to a vehicle be curbed.

The present invention provides a disc brake enabled to curb removal of a cover member in a state of being attached to a vehicle.

### Solution to Problem

According to a first aspect of the present invention, a disc brake for braking a vehicle having a disc rotating together with a wheel includes an attachment member attached to a non-rotation portion of the vehicle, a caliper, and a cover member.

The caliper is movably provided in the attachment member, and presses a pair of brake pads against the disc. This caliper includes a cylinder portion, a bridge portion, a plurality of claws, and a recessed portion. The cylinder portion has a cylinder hole in which a piston for moving one of the pair of brake pads is disposed. The bridge portion extends from the cylinder portion across an outer circumferential surface of the disc. The plurality of claws are formed on an extension tip side of the bridge portion and are disposed in a manner of facing the cylinder portion. The recessed portion is provided between the plurality of claws, has an opening portion at an inner end in a radial direction with respect to a rotation axis of the disc, and is formed in a manner of opposing the cylinder hole. A cover member fixing hole is formed in an inner circumference of the recessed portion in a manner of being inclined with respect to the radial direction.

The cover member is fixed to the caliper by a fixing member engaging with the cover member fixing hole and covers the recessed portion in a direction of the rotation axis.

According to a second aspect of the present invention, a disc brake for braking a vehicle having a disc rotating together with a wheel includes an attachment member attached to a non-rotation portion of the vehicle, a caliper, and a cover member.

The caliper is movably provided in the attachment member, and presses a pair of brake pads against the disc. This caliper includes a cylinder portion, a bridge portion, a plurality of claws, and a recessed portion. The cylinder portion has a cylinder hole in which a piston for moving one of the pair of brake pads is disposed. The bridge portion extends from the cylinder portion across an outer circumferential surface of the disc. The plurality of claws are formed on an extension tip side of the bridge portion and are disposed in a manner of facing the cylinder portion. The recessed portion is provided between the plurality of claws, has an opening portion at an inner end in a radial direction with respect to a rotation axis of the disc, and is formed in a manner of opposing the cylinder hole. A cover member fixing hole is provided in an inner circumference of the recessed portion.

The cover member is fixed to the caliper by a fixing member engaging with the cover member fixing hole, and covers the recessed portion in a direction of the rotation axis. This cover member includes a first cover portion and a second cover portion. The first cover portion extends in the radial direction. The second cover portion is connected to the first cover portion, and extends in the direction of the rotation axis toward the closer brake pad of the pair of brake pads. The second cover portion covers the cover member fixing hole when viewed in the radial direction.

### Advantageous Effects of Invention

According to the foregoing disc brake, it is possible to curb removal of a cover member from the disc brake in a state of being attached to a vehicle.

### BRIEF DESCRIPTION OF DRAWINGS

FIG. 1 A front view showing a disc brake and a disc in a first embodiment.

FIG. 2 A perspective view of the disc brake and the disc in the first embodiment viewed from the inward side in a disc radial direction.

FIG. 3 A view of the disc brake in the first embodiment viewed from the inward side in the disc radial direction.

FIG. 4 A perspective view of the disc brake in the first embodiment viewed from the inward side in the disc radial direction.

FIG. 5 A front view showing a caliper body of the disc brake in the first embodiment.

FIG. 6 A perspective view of the caliper body of the disc brake in the first embodiment viewed from the inward side in the disc radial direction. FIG. 7 An exploded perspective view of the caliper body and a cover member of the disc brake in the first embodiment viewed from the inward side in the disc radial direction.

FIG. 8 An exploded side sectional view showing the caliper body, the cover member, and a fixing member of the disc brake in the first embodiment.

FIG. 9 A perspective view showing the cover member of the disc brake in the first embodiment viewed from the rear surface side.

FIG. 10 A perspective view showing the cover member of the disc brake in the first embodiment viewed from the front surface side.

FIG. 11 A side sectional view showing the caliper body, the cover member, the fixing member, and a brake pad on the outer side of the disc brake in the first embodiment.

FIG. 12 A side sectional view showing a caliper body, a cover member, a fixing member, and the brake pad on the outer side of a disc brake in a second embodiment.

FIG. 13 A side sectional view showing a caliper body, a cover member, a fixing member, and the brake pad on the outer side of a disc brake in a third embodiment.

FIG. 14 A side sectional view showing a caliper body, a cover member, a fixing member, and the brake pad on the outer side of a disc brake in a fourth embodiment.

FIG. 15 A front view showing a caliper body of a disc brake in a fifth embodiment.

FIG. 16 A perspective view of the caliper body, a cover member, and a fixing member of the disc brake in the fifth embodiment viewed from the inward side in the disc radial direction.

FIG. 17 A cross-sectional view of the caliper body, the cover member, and the fixing member of the disc brake in the fifth embodiment viewed from the inner side.

FIG. 18 A side sectional view showing the caliper body, the cover member, the fixing member, and the brake pad on the outer side of the disc brake in the fifth embodiment.

### DESCRIPTION OF EMBODIMENTS

### First Embodiment

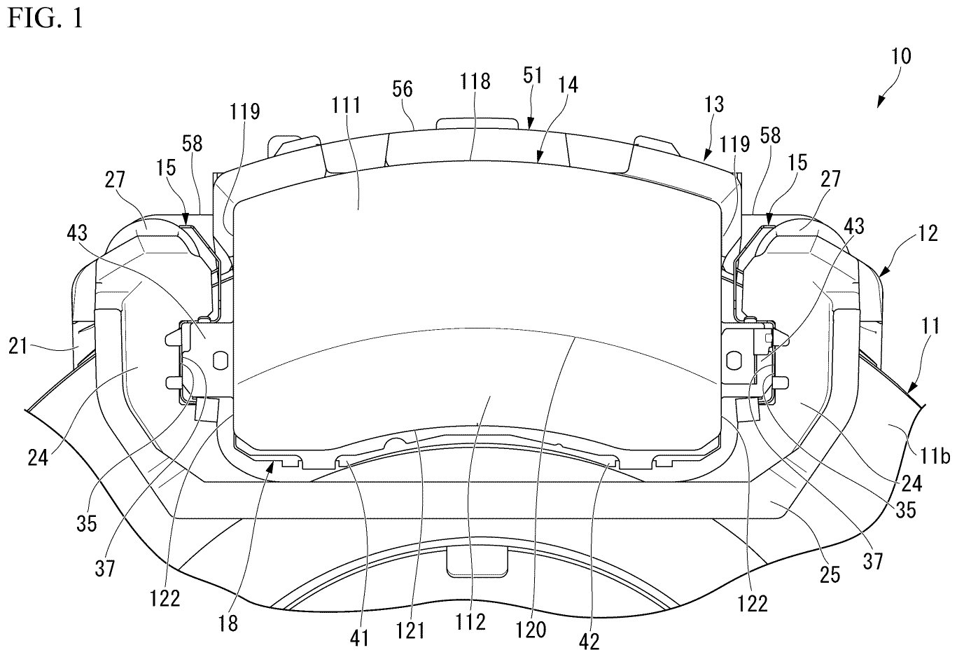

A first embodiment will be described below with reference to FIGS. 1 to 11.

A disc brake 10 of the first embodiment (shown in FIGS. 1 to 4) is used for a vehicle such as an automobile and applies a braking force to the vehicle. Specifically, it is a disc brake for braking a front wheel of a four-wheeled automobile.

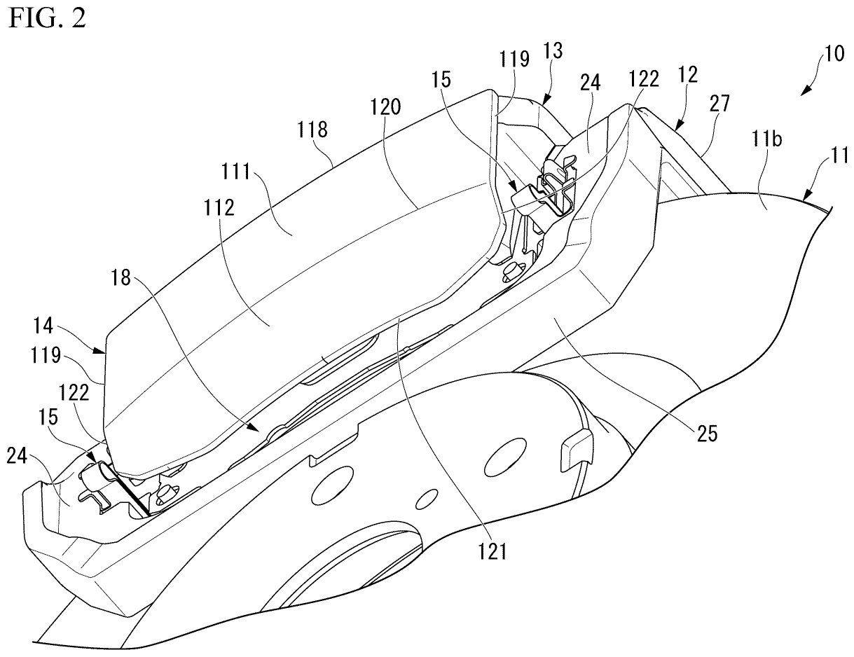

The disc brake 10 brakes a vehicle having a disc 11 by stopping rotation of the circular plate-shaped disc 11 (a part of which is shown in FIGS. 1 and 2) which rotates together with a wheel (not shown).

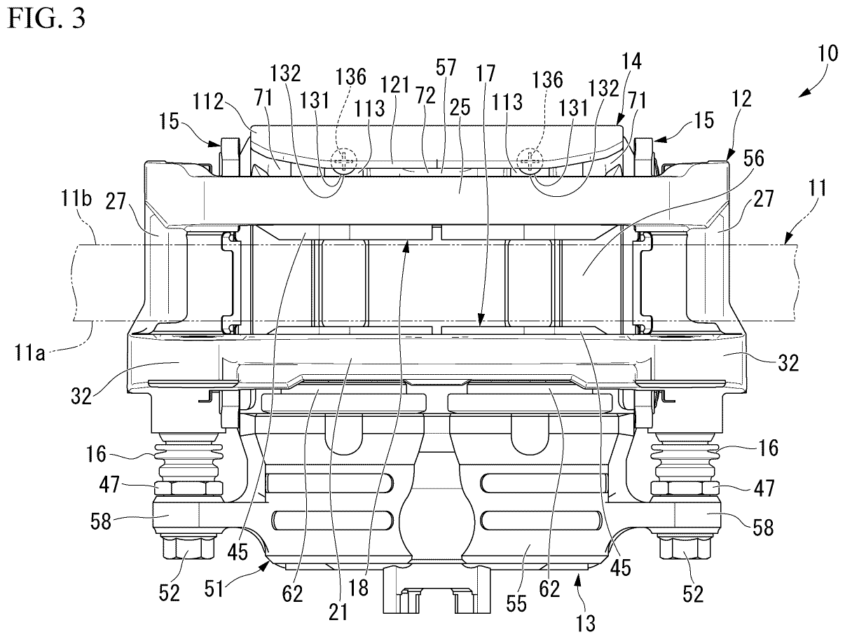

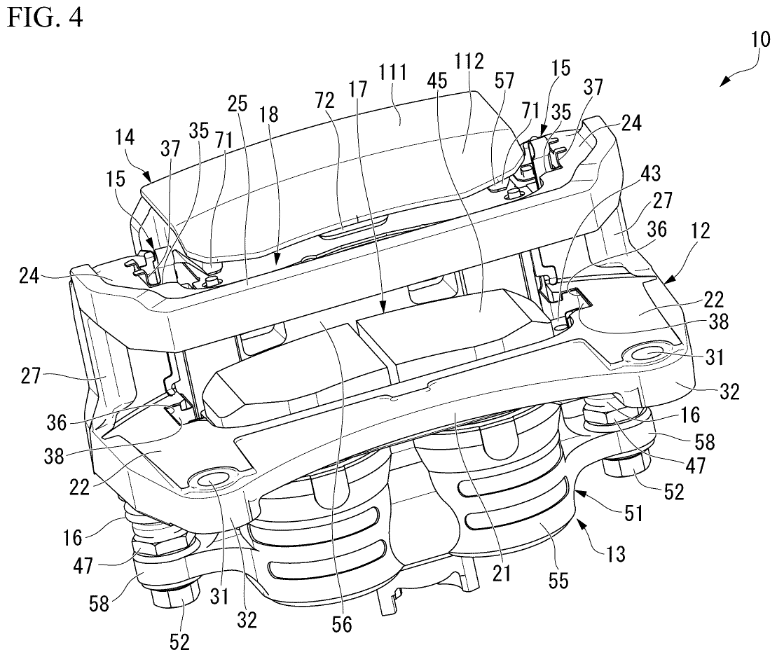

The disc brake 10 includes an attachment member 12, a caliper 13, a cover member 14, a pair of pad springs 15, and a pair of boots 16 (refer to FIG. 3). In addition, as shown in FIGS. 3 and 4, the disc brake 10 includes a pair of brake pad 17 and the brake pad 18.

Hereinafter, a rotation axis about which the disc 11 rotates will be referred to as a disc axis, and a direction in which the disc axis extends will be referred to as a disc axial direction. A radial direction of the disc 11 inside the disc brake 10, that is, a radial direction with respect to the rotation axis of the disc 11 will be referred to as a disc radial direction. A circumferential direction of the disc 11 inside the disc brake 10, that is, a circumferential direction with respect to the rotation axis of the disc 11 will be referred to as a disc circumferential direction. The disc axis side in the disc radial direction will be referred to as an inward side in the disc radial direction. A side opposite to the disc axis in the disc radial direction will be referred to as an outward side in the disc radial direction. The center side in the disc circumferential direction will be referred to as an inward side in the disc circumferential direction. A side opposite to the center in the disc circumferential direction will be referred to as an outward side in the disc circumferential direction. A line passing through the disc axis and the center of the disc brake 10 in the disc circumferential direction and lying in the disc radial direction will be referred to as a radial reference line. This radial reference line is orthogonal to the disc axis. In addition, a plane including both the radial reference line and the disc axis will be referred to as a radial reference plane. In addition, an outward side in a vehicle width direction of a vehicle to which the disc brake 10 is attached will be referred to as an outer side, and an inward side therein will be referred to as an inner side.

As shown in FIG. 4, the attachment member 12 has an inner beam portion 21, a pair of inner side pad support portions 22, a pair of outer side pad support portions 24, an outer beam portion 25, and a pair of pin insertion fitted portions 27.

The pair of inner side pad support portions 22 include one inner side pad support portion 22 and the other inner side pad support portion 22. The pair of pin insertion fitted portions 27 include one pin insertion fitted portion 27 and the other pin insertion fitted portion 27. The pair of outer side pad support portions 24 include one outer side pad support portion 24 on one side in the disc circumferential direction and the other outer side pad support portion 24 on the other side in the disc circumferential direction.

The attachment member 12 is a casting which is integrally formed by casting and has a shape which is mirror symmetrical with respect to the radial reference plane.

As shown in FIG. 3, the inner beam portion 21 is disposed on one side in the disc axial direction with respect to the disc 11 and is fixed to a non-rotation portion of the vehicle. Thus, the attachment member 12 including the inner beam portion 21 is attached to a non-rotation portion of the vehicle. Here, a non-rotation part of the vehicle, to which the inner beam portion 21 of the attachment member 12 is fixed, is disposed on the inner side with respect to the disc 11. Thus, the inner beam portion 21 attached to this non-rotation part is also disposed on the inner side with respect to the disc 11. Hereinafter, the disc brake 10 will be described in a state of being attached to a non-rotation portion of the vehicle in the inner beam portion 21 of the attachment member 12.

The inner beam portion 21 is disposed in a manner of extending in the disc circumferential direction. As shown in FIG. 4, in the inner beam portion 21, a pair of attachment boss portions 32 respectively having attachment holes 31 are provided in both end parts on the outward sides in the disc circumferential direction. The inner beam portion 21 is attached to a non-rotation part of the vehicle by bolts (not shown) screwed into the respective attachment holes 31 in the pair of attachment boss portions 32.

The one inner side pad support portion 22 extends to the outward side in the disc radial direction from one end portion of the inner beam portion 21 on the outward side in the disc circumferential direction. The other inner side pad support portion 22 extends to the outward side in the disc radial direction from the other end portion of the inner beam portion 21 on the outward side in the disc circumferential direction. Similarly to the inner beam portion 21, the pair of inner side pad support portions 22 are disposed on the inner side with respect to the disc 11.

The one pin insertion fitted portion 27 extends across the outer circumferential side of the disc 11 in the disc axial direction from the end portion on the outward side in the disc radial direction of the inner side pad support portion 22 on one side in the disc circumferential direction. The other pin insertion fitted portion 27 extends across the outer circumferential side of the disc 11 in the disc axial direction from the end portion on the outward side in the disc radial direction of the inner side pad support portion 22 on the other side in the disc circumferential direction.

The one outer side pad support portion 24 on one side in the disc circumferential direction extends to the inward side in the disc radial direction from the end portion on a side opposite to the inner side pad support portion 22, that is, on the outer side of the pin insertion fitted portion 27 on one side in the disc circumferential direction. The other outer side pad support portion 24 on the other side in the disc circumferential direction extends to the inward side in the disc radial direction from the end portion on the outer side of the pin insertion fitted portion 27 on the other side in the disc circumferential direction. The pair of outer side pad support portions 24 are disposed on the outer side with respect to the disc 11.

The outer beam portion 25 extends in the disc circumferential direction and joins the end portions of the pair of outer side pad support portions 24 on the inward side in the disc radial direction to each other. Similarly to the pair of outer side pad support portions 24, the outer beam portion 25 is disposed on the outer side with respect to the disc 11.

As above, the attachment member 12 is provided across the outer circumferential side of the disc 11 and is fixed to a non-rotation part of the vehicle. The inner beam portion 21 and the pair of inner side pad support portions 22 are disposed on the inner side of the attachment member 12, which is a side attached to a non-rotation part of the vehicle. The pair of outer side pad support portions 24 and the outer beam portion 25 are disposed on the outer side of the attachment member 12, which is opposite to the inner side.

Pad guide portions 35 are formed in the pair of outer side pad support portions 24 on respective sides facing each other. These pad guide portions 35 have shapes recessed in directions in which they are separated from each other in the disc circumferential direction. Pad guide portions 36 are formed in the pair of inner side pad support portions 22 on respective sides facing each other. These pad guide portions 36 have shapes recessed in directions in which they are separated from each other in the disc circumferential direction.

One pad spring 15 of the pair of pad springs 15 is attached to the inner side pad support portion 22 and the outer side pad support portion 24 on one side in the disc circumferential direction. This pad spring 15 has a recessed guide portion 37 fitted into the recessed pad guide portion 35 of the outer side pad support portion 24 on one side in the disc circumferential direction.

In addition, this pad spring 15 has a recessed guide portion 38 fitted into the recessed pad guide portion 36 of the inner side pad support portion 22 on the same one side in the disc circumferential direction.

The other pad spring 15 of the pair of pad springs 15 is attached to the inner side pad support portion 22 and the outer side pad support portion 24 on the other side in the disc circumferential direction. This pad spring 15 has a recessed guide portion 37 fitted into the recessed pad guide portion 35 of the outer side pad support portion 24 on the other side in the disc circumferential direction.

In addition, this pad spring 15 has a recessed guide portion 38 fitted into the recessed pad guide portion 36 of the inner side pad support portion 22 on the other side in the disc circumferential direction.

The brake pad 17 and the brake pad 18 are components having substantially the same shape. The brake pads 17 and 18 each have a rear plate 41, as in the brake pad 18 shown in FIG. 1. The rear plate 41 has a main body portion 42 in the middle in the disc circumferential direction and has ear portions 43 at both respective end portions on the outward sides in the disc circumferential direction. As shown in FIG. 3, the brake pads 17 and 18 respectively have linings 45. The lining 45 is adhered to a surface on one side in a thickness direction of the main body portion 42 (shown in FIG. 1) of the corresponding rear plate 41.

The brake pad 18 of the brake pads 17 and 18 is disposed on the outer side. As shown in FIG. 1, in the brake pad 18, the ear portions 43 at both ends on the outward sides in the disc circumferential direction are fitted into the respective pad guide portions 35 of the pair of outer side pad support portions 24 via the guide portions 37 disposed on the respective outer sides of the pair of pad springs 15. At this time, the pair of pad springs 15 elastically support this brake pad 18. In this manner, the brake pad 18 on the outer side is movably supported by the pair of outer side pad support portions 24 of the attachment member 12 in the disc axial direction via the pair of pad springs 15.

The brake pad 17 of the brake pads 17 and 18 is disposed on the inner side. In the brake pad 17, the ear portions 43 (only one is shown in FIG. 4) at both ends on the outward sides in the disc circumferential direction are fitted into the respective pad guide portions 36 of the pair of inner side pad support portions 22 via the guide portions 38 disposed on the respective inner sides of the pair of pad springs 15. At this time, the pair of pad springs 15 elastically support this brake pad 17. In this manner, the brake pad 17 on the inner side is movably supported by the pair of inner side pad support portions 22 of the attachment member 12 in the disc axial direction via the pair of pad springs 15.

As shown in FIG. 3, in both the brake pads 17 and 18, the linings 45 face the disc 11. Thus, in both the brake pads 17 and 18, the linings 45 come into contact with the disc 11. The pair of brake pads 17 and 18 supported by the attachment member 12 via the pair of pad springs 15 can move in the disc axial direction with respect to the attachment member 12.

The brake pad 17 on the inner side is movably provided in the attachment member 12. The brake pad 17 is disposed in a manner of facing one surface 11a on the inner side of the surfaces 11a and 11b on both sides of the disc 11 in the disc axial direction. The brake pad 18 on the outer side is movably provided in the attachment member 12. The brake pad 18 is disposed in a manner of facing the other surface 11b on the outer side of the surfaces 11a and 11b on both sides of the disc 11 in the disc axial direction.

In the attachment member 12, pin insertion holes (not shown) extending in the disc axial direction are formed in the pair of respective pin insertion fitted portions 27 on both sides in the disc circumferential direction (shown in FIG. 4). A pair of slide pins 47 on both sides of the caliper 13 in the disc circumferential direction are slidably fitted into these pin insertion holes. Accordingly, the attachment member 12 supports the caliper 13 with the pair of pin insertion fitted portions 27 thereof in a manner of being slidable in the disc axial direction. In other words, in the caliper 13, the pair of slide pins 47 provided on both sides in the disc circumferential direction are respectively fitted into the pin insertion holes (not shown) of the pair of pin insertion fitted portions 27 of the attachment member 12 in a slidable manner. Accordingly, it is provided in the attachment member 12 in a manner of being movable in the disc axial direction. The pair of boots 16 respectively cover the slide pins 47 protruding from the pin insertion fitted portions 27.

The caliper 13 has a caliper body 51, the pair of slide pins 47, and a pair of pin attachment bolts 52. The caliper 13 has a shape which is substantially mirror symmetrical with respect to the radial reference plane.

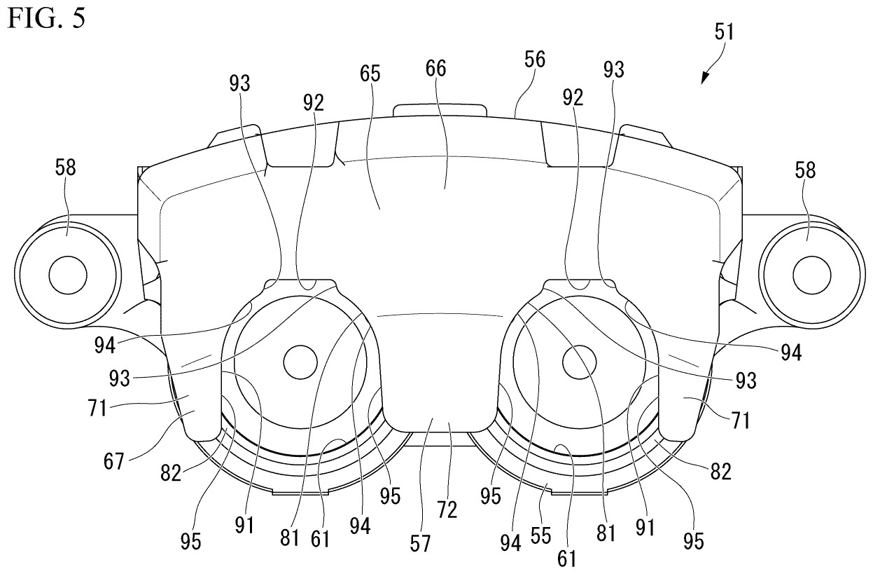

The caliper body 51 is integrally formed by casting. As shown in FIGS. 5 to 7, the caliper body 51 has cylinder portions 55, a bridge portion 56, and a facing portion 57. Thus, the caliper 13 including the caliper body 51 has the cylinder portions 55, the bridge portion 56, and the facing portion 57.

As shown in FIG. 3, the cylinder portions 55 are disposed on the inner side in the disc axial direction with respect to the disc 11. The bridge portion 56 extends to the outer side in the disc axial direction from the outward sides of the cylinder portions 55 in the disc radial direction. In other words, the bridge portion 56 is provided across the outer circumferential surface of the disc 11 from the cylinder portions 55. The facing portion 57 extends to the inward side in the disc radial direction from a side of the bridge portion 56 opposite to the cylinder portions 55 in the disc axial direction and is disposed on the outer side in the disc axial direction with respect to the disc 11.

The caliper body 51 has a pair of pin attachment portions 58 extending to both sides in the disc circumferential direction from the cylinder portions 55. One slide pin 47 is attached to one pin attachment portion 58 of the pair of pin attachment portions 58 using one pin attachment bolt 52. The other slide pin 47 is attached to the other pin attachment portion 58 of the pair of pin attachment portions 58 using the other pin attachment bolt 52.

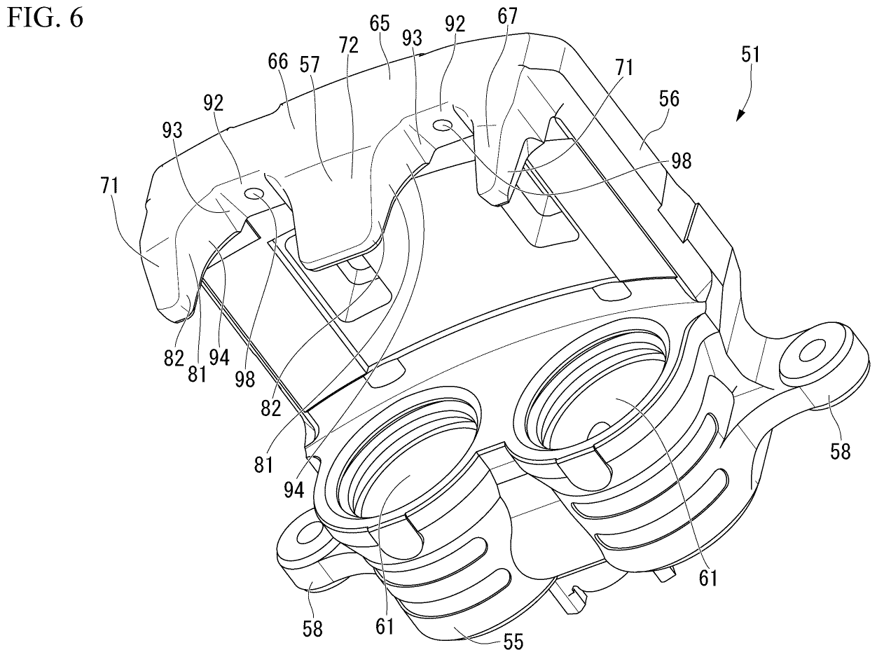

As shown in FIGS. 5 and 6, a pair of cylinder holes 61 are formed in the cylinder portions 55. Both the pair of cylinder holes 61 have a shape in which one end opens toward the facing portion 57 side and is recessed toward a side opposite to the facing portion 57 in the disc axial direction. In other words, both the pair of cylinder holes 61 are recessed in the cylinder portions 55 toward a side opposite to the disc 11. Both the pair of cylinder holes 61 lie in the disc axial direction. The pair of cylinder holes 61 have the same shape, are provided in the cylinder portions 55 in a manner of being positionally aligned in the disc axial direction and the disc radial direction, are positionally shifted in the disc circumferential direction, and are arranged side by side in the disc circumferential direction. The caliper 13 is a so-called twin bore caliper having two cylinder holes 61. The two cylinder holes 61 include one cylinder hole 61 and the other cylinder hole 61.

In the cylinder holes 61, pistons 62 (shown in FIG. 3) are respectively disposed in a manner of being movable in the disc axial direction. In other words, the cylinder portions 55 have the cylinder holes 61 in which the pistons 62 are accommodated. The caliper 13 accommodates the pistons 62 in a manner of being movable in the disc axial direction.

As shown in FIG. 6, the facing portion 57 is provided in a manner of facing the cylinder portions 55 in the disc axial direction. The facing portion 57 positionally overlaps the cylinder portions 55 in the disc radial direction and the disc circumferential direction.

The brake pad 18 on the outer side (shown in FIG. 3) is supported by the attachment member 12 and is disposed between the facing portion 57 and the disc 11. The brake pad 17 on the inner side is supported by the attachment member 12 and is disposed between the cylinder portions 55 and the pair of pistons 62 provided in the cylinder portions 55, and the disc 11. The pair of pistons 62 face the brake pad 17 on the inner side in the disc axial direction. The pair of pistons 62 move the brake pad 17 to the disc 11 side in the disc axial direction.

As shown in FIG. 6, in the caliper body 51, an end surface 65 on a side opposite to the cylinder portions 55 in the disc axial direction has a main surface portion 66 and an inclined surface portion 67.

The main surface portion 66 is on the end surface 65 on the outward side in the disc radial direction. The main surface portion 66 has a planar shape extending perpendicularly to the disc axis.

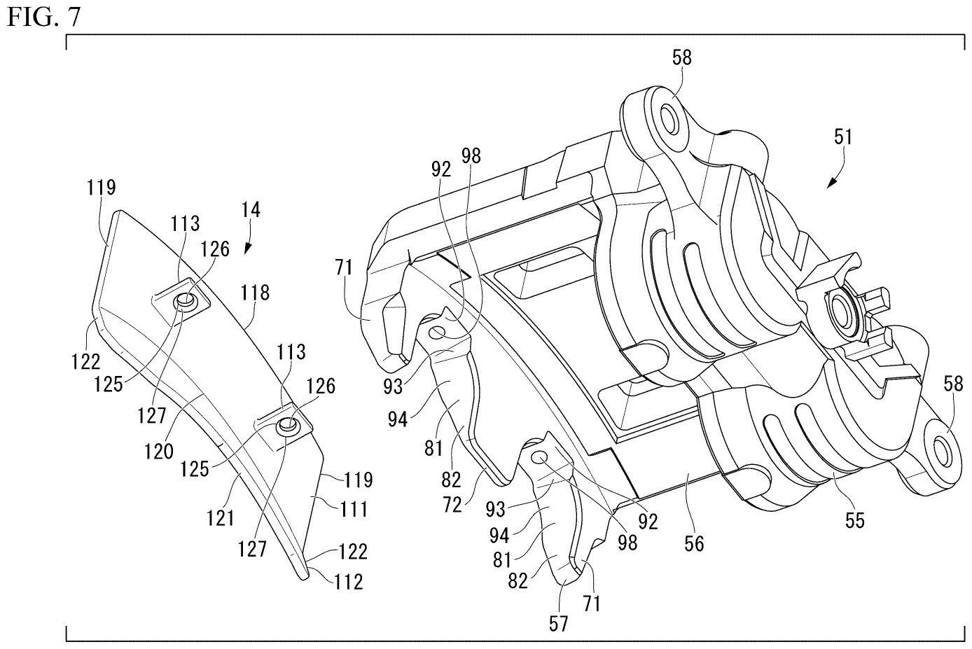

The inclined surface portion 67 is on the end surface 65 on the inward side in the disc radial direction. The inclined surface portion 67 extends to the inward side in the disc radial direction from an end edge portion of the main surface portion 66 on the inward side in the disc radial direction. When viewed in the disc circumferential direction, as shown in FIG. 8, the inclined surface portion 67 is inclined in a manner of being positioned on the cylinder portions 55 side in the disc axial direction as it goes toward the inward side in the disc radial direction.

As shown in FIGS. 5 and 6, the facing portion 57 has a pair of outer claws 71 (claws) in both outward side end portions in the disc circumferential direction, and an intermediate claw 72 (claw) between the pair of outer claws 71 in the disc circumferential direction. The pair of outer claws 71 include one outer claw 71 and the other outer claw 71. All the pair of outer claws 71 and the intermediate claw 72 are on a side of the bridge portion 56 opposite to the cylinder portions 55 in the disc axial direction, extend to the inward side in the disc radial direction from the bridge portion 56, and are positioned on the outer side in the disc axial direction with respect to the disc 11.

In other words, all the pair of outer claws 71 and the intermediate claw 72 are formed on the tip side of the bridge portion 56 in the extending direction from the cylinder portions 55. All the pair of outer claws 71 and the intermediate claw 72 positionally overlap the cylinder portions 55 in the disc circumferential direction and the disc radial direction and are disposed in a manner of facing the cylinder portions 55 in the disc axial direction. The pair of outer claws 71 each have a width in the disc circumferential direction smaller than the width of the intermediate claw 72 in the disc circumferential direction.

On the end surface 65 of the caliper body 51, the main surface portion 66 is formed by the bridge portion 56 and parts of the pair of outer claws 71 and the intermediate claw 72 on the outward side in the disc radial direction. On the end surface 65 of the caliper body 51, the inclined surface portion 67 is formed in parts of the pair of outer claws 71 and the intermediate claw 72 on the inward side in the disc radial direction from the main surface portion 66.

The one outer claw 71, the intermediate claw 72, and the other outer claw 71 are disposed apart from each other in the disc circumferential direction. Accordingly, in the facing portion 57, a part between the one outer claw 71 and the intermediate claw 72 adjacent thereto in the disc circumferential direction becomes a recessed portion 81 penetrating it in the disc axial direction and having a shape opening inward in the disc radial direction. In addition, in the facing portion 57, a part between the intermediate claw 72 and the other outer claw 71 adjacent thereto in the disc circumferential direction becomes the recessed portion 81 penetrating it in the disc axial direction and having a shape opening inward in the disc radial direction. In other words, the recessed portions 81 are provided between the outer claws 71 and the intermediate claw 72 and have a shape recessed toward the outward side in the disc radial direction from the end portion of the facing portion 57 on the inward side in the disc radial direction. The recessed portions 81 have opening portions 82 in their end portions on the inward side in the disc radial direction.

As described above, since the facing portion 57 have three claws, such as the pair of outer claws 71 and the intermediate claw 72, there are provided a pair of, that is, two recessed portions 81. The two recessed portions 81 include one recessed portion 81 and the other recessed portion 81. In the caliper body 51, the recessed portions 81 are formed in a manner of respectively facing the pair of cylinder holes 61 in the disc axial direction. That is, the caliper body 51 is provided with the same number of recessed portions 81 as that of the cylinder holes 61. The two recessed portions 81 are positionally aligned with each other in the disc axial direction and the disc radial direction and are separated from each other in the disc circumferential direction.

The one recessed portion 81 provided between the one outer claw 71 and the intermediate claw 72 positionally overlaps the one cylinder hole 61 in the disc circumferential direction and the disc radial direction and faces it in the disc axial direction. This one recessed portion 81 is a part through which a tool for machining the inside of this one cylinder hole 61 that faces is inserted.

The other recessed portion 81 provided between the other outer claw 71 and the intermediate claw 72 positionally overlaps the other cylinder hole 61 in the disc circumferential direction and the disc radial direction and faces it in the disc axial direction. The other recessed portion 81 is a part through which a tool for machining the inside of the other cylinder hole 61 that faces is inserted.

In other words, in the facing portion 57, the one recessed portion 81 is formed in a manner of opposing the one cylinder hole 61, and the other recessed portion 81 is formed in a manner of opposing the other cylinder hole 61. The caliper body 51, that is, the caliper 13 including the caliper body 51 has the pair of recessed portions 81.

These recessed portions 81 have a shape which is mirror symmetrical with respect to the radial reference plane. These recessed portions 81 are provided side by side in the disc circumferential direction in a manner of being positionally aligned in the disc axial direction and the disc radial direction, and are positionally shifted in the disc circumferential direction. Since the two recessed portions 81 have a shape which is mirror symmetrical with respect to the radial reference plane, the one recessed portion 81 will be described herein as an example.

As shown in FIG. 5, an inner circumferential surface 91 of the recessed portion 81 has a bottom surface portion 92 (recessed bottom surface portion), a pair of bottom side wall surface portions 93, a pair of arc-shaped surface portions 94, and a pair of opening side wall surface portions 95.

The pair of bottom side wall surface portions 93 include the bottom side wall surface portion 93 on the outward side in the disc circumferential direction and the bottom side wall surface portion 93 on the inward side in the disc circumferential direction. The pair of arc-shaped surface portions 94 include the arc-shaped surface portion 94 on the outward side in the disc circumferential direction and the arc-shaped surface portion 94 on the inward side in the disc circumferential direction. The pair of opening side wall surface portions 95 include the opening side wall surface portion 95 on the outward side in the disc circumferential direction and the opening side wall surface portion 95 on the inward side in the disc circumferential direction.

The bottom surface portions 92 are formed in center portions of the recessed portions 81 in the disc circumferential direction. The bottom surface portions 92 are provided at positions in the recessed portions 81 facing the opening portions 82 in the disc radial direction. The bottom surface portions 92 are provided at positions in the end portions of the recessed portions 81 on a side opposite to the opening portions 82 in a direction in which the radial reference line extends. The bottom surface portions 92 have a planar shape. The bottom surface portions 92 extend perpendicularly to the radial reference line when viewed in the disc axial direction. As shown in FIG. 8, when viewed in the disc circumferential direction, the bottom surface portions 92 extend in a manner of being positioned on the outward side in the disc radial direction as they approach the cylinder portions 55 in the disc axial direction. Thus, the bottom surface portions 92 extend perpendicularly to the radial reference plane and extend in a manner of being positioned on the outward side in the disc radial direction as they approach the cylinder portions 55 in the disc axial direction.

As shown in FIG. 5, both the pair of bottom side wall surface portions 93 have substantially a planar shape, are positionally aligned with each other in the disc axial direction and the disc radial direction, and are separated from each other in the disc circumferential direction. The bottom side wall surface portion 93 on the outward side in the disc circumferential direction extends to the inward side in the disc radial direction from the end edge portion of the bottom surface portion 92 on the outward side in the disc circumferential direction. The bottom side wall surface portion 93 on the inward side in the disc circumferential direction extends to the inward side in the disc radial direction from the end edge portion of the bottom surface portion 92 on the inward side in the disc circumferential direction. Both the pair of bottom side wall surface portions 93 lie in the disc axial direction. A space between the pair of bottom side wall surface portions 93 increases in the disc circumferential direction as it goes toward the inward side in the disc radial direction. The pair of bottom side wall surface portions 93 have a mirror symmetrical shape.

Both the pair of arc-shaped surface portions 94 have a shape of a part on a cylinder surface, are positionally aligned with each other in the disc axial direction and the disc radial direction, and are separated from each other in the disc circumferential direction. The arc-shaped surface portion 94 on the outward side in the disc circumferential direction extends inward in the disc radial direction from the end edge portion of the bottom side wall surface portion 93 on the outward side in the disc circumferential direction on a side opposite to the bottom surface portion 92. This arc-shaped surface portion 94 is positioned on the outward side in the disc circumferential direction as it goes inward in the disc radial direction. This arc-shaped surface portion 94 forms a shape of a part on a cylinder surface having the center axis of the opposing cylinder hole 61 as its center axis. The arc-shaped surface portion 94 on the inward side in the disc circumferential direction extends inward in the disc radial direction from the end edge portion of the bottom side wall surface portion 93 on the inward side in the disc circumferential direction on a side opposite to the bottom surface portion 92. This arc-shaped surface portion 94 is positioned on the inward side in the disc circumferential direction as it goes inward in the disc radial direction. This arc-shaped surface portion 94 forms a shape of a part on a cylinder surface having the center axis of the opposing cylinder hole 61 as its center axis. Both the pair of arc-shaped surface portions 94 lie in the disc axial direction. A space between the pair of arc-shaped surface portions 94 increases in the disc circumferential direction as it goes toward the inward side in the disc radial direction. The pair of arc-shaped surface portions 94 have a mirror symmetrical shape.

Both the pair of opening side wall surface portions 95 have substantially a planar shape, are positionally aligned with each other in the disc axial direction and the disc radial direction, and are separated from each other in the disc circumferential direction. The opening side wall surface portion 95 on the outward side in the disc circumferential direction extends inward in the disc radial direction from the end edge portion of the arc-shaped surface portion 94 on the outward side in the disc circumferential direction on a side opposite to the bottom side wall surface portion 93. This opening side wall surface portion 95 is positioned on the outward side in the disc circumferential direction as it goes inward in the disc radial direction. The opening side wall surface portion 95 on the inward side in the disc circumferential direction extends inward in the disc radial direction from the end edge portion of the arc-shaped surface portion 94 on the inward side in the disc circumferential direction on a side opposite to the bottom side wall surface portion 93. This opening side wall surface portion 95 is positioned on the inward side in the disc circumferential direction as it goes inward in the disc radial direction. Both the pair of opening side wall surface portions 95 lie in the disc axial direction. A space between the pair of opening side wall surface portions 95 increases in the disc circumferential direction as it goes toward the inward side in the disc radial direction. The pair of opening side wall surface portions 95 have a mirror symmetrical shape.

The foregoing recessed portions 81 have a shape which is mirror symmetrical with respect to a plane parallel to the radial reference plane.

The caliper body 51 is provided with two recessed portions 81 having the foregoing shape side by side in the disc circumferential direction. In the two recessed portions 81, the respective bottom surface portions 92 are disposed in the same plane. The two recessed portions 81 include one recessed portion 81 and the other recessed portion 81. The respective bottom surface portions 92 of the two recessed portions 81 include one bottom surface portion 92 and the other bottom surface portion 92.

As shown in FIGS. 6 and 7, the caliper body 51 has two cover member fixing holes 98. The two cover member fixing holes 98 include one cover member fixing hole 98 and the other cover member fixing hole 98. The one cover member fixing hole 98 is formed at a position in the bottom surface portion 92 of the one recessed portion 81.

The other cover member fixing hole 98 is formed at a position in the bottom surface portion 92 of the other recessed portion 81.

These cover member fixing holes 98 have a shape which is mirror symmetrical with respect to the radial reference plane. These cover member fixing holes 98 are provided side by side in the disc circumferential direction in a manner of being positionally aligned in the disc axial direction and the disc radial direction, and are positionally shifted in the disc circumferential direction. Since the two cover member fixing holes 98 have a mirror symmetrical shape, the one cover member fixing hole 98 will be described herein as an example.

The cover member fixing holes 98 are formed perpendicularly to the bottom surface portions 92, as shown in FIG. 8, from center positions in the bottom surface portions 92 in the disc circumferential direction and intermediate positions in the disc axial direction. Thus, the cover member fixing holes 98 extend parallel to the radial reference line when viewed in the disc axial direction. When viewed in the disc circumferential direction, the cover member fixing holes 98 extend in a manner of approaching the cylinder portions 55 in the disc axial direction as they go toward the inward side in the disc radial direction. Thus, the cover member fixing holes 98 are provided in inner circumferences of the recessed portions 81 and are formed in a manner of being inclined with respect to the disc radial direction. A virtual line X1 drawn in a direction in which the cover member fixing holes 98 extend does not pass through the outer claws 71 and the intermediate claw 72 shown in FIGS. 6 and 7. The cover member fixing holes 98 are screw holes in which a female screw portion is formed in an inner circumferential portion.

The caliper body 51 is provided with the foregoing two cover member fixing holes 98 side by side in the disc circumferential direction.

As shown in FIGS. 7 to 11, the cover member 14 includes a first cover portion 111 and a second cover portion 112. As shown in FIGS. 7 to 9 and 11, the cover member 14 includes protrusion portions 113. For example, the cover member 14 is an integrally molded product made of a synthetic resin. The cover member 14 is not limited to being made of a synthetic resin and may be integrally molded using a metal material such as an aluminum alloy. As shown in FIG. 7, the cover member 14 is provided with two protrusion portions 113, the same number as the number of recessed portions 81. The cover member 14 has a mirror symmetrical shape.

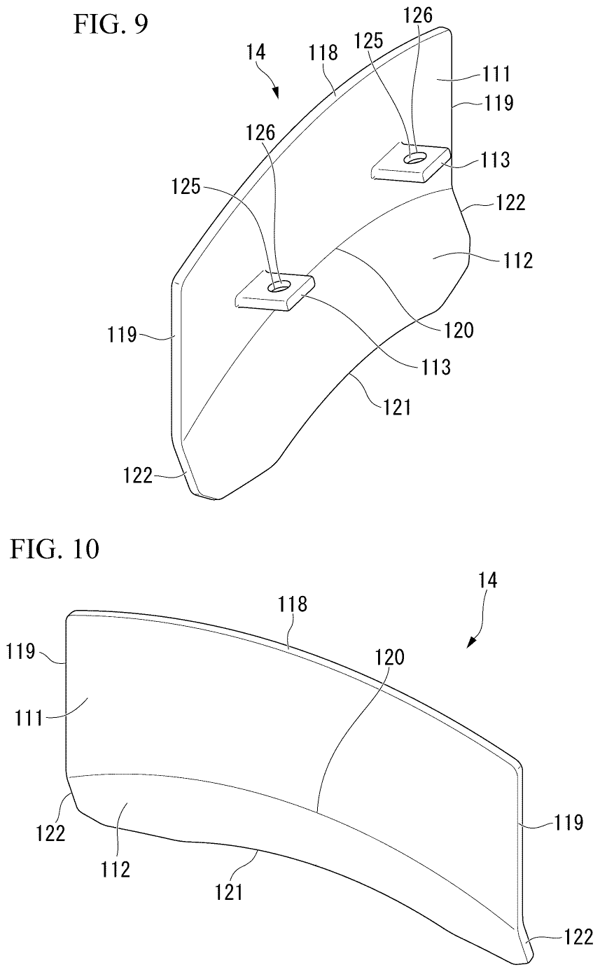

As shown in FIG. 10, the first cover portion 111 has substantially a rectangular plate shape. In the first cover portion 111, an end edge portion 118 constituting one long side has an arc shape projecting toward the outward side of the first cover portion 111 in a direction in which a pair of end edge portions 119 on both sides constituting short sides extend. In the first cover portion 111, an end edge portion 120 constituting the other long side on a side opposite to the end edge portion 118 in a direction in which the pair of end edge portions 119 extend has an arc shape recessed toward the inward side of the first cover portion 111 in a direction in which the pair of end edge portions 119 extend.

The second cover portion 112 has substantially a rectangular plate shape. The second cover portion 112 extends in a direction in which it is separated from the first cover portion 111 in a direction in which the pair of end edge portions 119 of the first cover portion 111 extend from the end edge portion 120 of the first cover portion 111. The second cover portion 112 is inclined with respect to the first cover portion 111 in a manner of being separated from the first cover portion 111 to one side of the first cover portion 111 in the thickness direction as it is separated from the first cover portion 111 in a direction in which the pair of end edge portions 119 of the first cover portion 111 extend. The angle on the small side formed by the first cover portion 111 and the second cover portion 112 is an obtuse angle.

One long side of the second cover portion 112 is constituted of the foregoing end edge portion 120. The second cover portion 112 has an end edge portion 121 constituting a long side opposite to the first cover portion 111, and a pair of end edge portions 122 on both sides constituting the short sides. As shown in FIG. 1, when the cover member 14 is viewed in the thickness direction of the first cover portion 111, one end edge portion 119 of the first cover portion 111 and one end edge portion 122 of the second cover portion 112 connected thereto has the same linear shape.

When the cover member 14 is viewed in the thickness direction of the first cover portion 111, the other end edge portion 119 of the first cover portion 111 and the other end edge portion 122 of the second cover portion 112 connected thereto has the same linear shape.

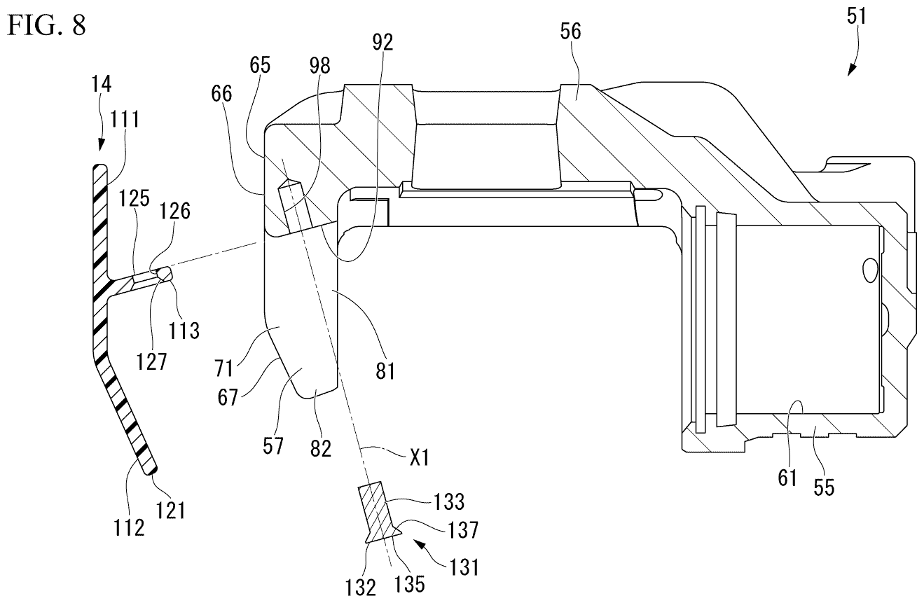

As shown in FIGS. 9 and 10, the length of the first cover portion 111 in a direction in which the pair of end edge portions 119 extend is longer than the length of the second cover portion 112 in a direction in which the pair of end edge portions 122 extend. Thus, the length of the first cover portion 111 in a direction in which the pair of end edge portions 119 extend is longer than the length of the second cover portion 112 in this direction.

As shown in FIGS. 7 and 9, both the two protrusion portions 113 have a plate shape and protrude to one side of the first cover portion 111 in the thickness direction from the first cover portion 111. The two protrusion portions 113 protrude from the first cover portion 111 to the same side as that in a direction in which the second cover portion 112 is inclined. The two protrusion portions 113 are disposed in the first cover portion 111 with a space therebetween in a direction in which the end edge portions 118 and 121 extend. Both the two protrusion portions 113 extend in a direction in which the end edge portions 118 and 121 extend. The two protrusion portions 113 are disposed in the same plane. The two protrusion portions 113 have a mirror symmetrical shape. For this reason, one protrusion portion 113 will be described herein as an example.

As shown in FIG. 8, the protrusion portions 113 are inclined with respect to the thickness direction of the first cover portion 111 in a manner of being separated from the second cover portion 112, as shown in FIG. 8, in a direction in which the pair of end edge portions 119 of the first cover portion 111 shown in FIG. 7 extend as they are separated from the first cover portion 111 in the thickness direction of the first cover portion 111.

In the protrusion portions 113, fixing member insertion holes 125 are formed perpendicularly to the thickness direction of the protrusion portions 113. Thus, the fixing member insertion holes 125 are inclined with respect to the first cover portion 111 in a manner of being separated from the first cover portion 111 in the thickness direction of the first cover portion 111 as they approach the second cover portion 112, as shown in FIG. 8, in a direction in which the pair of end edge portions 119 of the first cover portion 111 shown in FIG. 7 extend. The fixing member insertion holes 125 each have an insertion hole portion 126 and an interlock hole portion 127.

The insertion hole portion 126 is provided in a part on a side opposite to the second cover portion 112 of the fixing member insertion hole 125 in a direction in which the pair of end edge portions 119 of the first cover portion 111 extend. The insertion hole portion 126 has an inner circumferential surface having a cylinder surface shape.

The interlock hole portion 127 is provided in a part of the fixing member insertion hole 125 on the second cover portion 112 side in a direction in which the pair of end edge portions 119 of the first cover portion 111 extend. The interlock hole portion 127 has an inner circumferential surface having a tapered surface shape. The interlock hole portion 127 decreases in diameter as it approaches the insertion hole portion 126 in the axial direction, and a part having the smallest diameter is connected to the insertion hole portion 126.

The second cover portion 112 extends from the first cover portion 111 to a position overlapping the fixing member insertion holes 125 in the thickness direction of the first cover portion 111. The second cover portion 112 overlaps the insertion hole portions 126 in their entirety in the thickness direction of the first cover portion 111 and overlaps a part on the first cover portion 111 side including the center axes of the interlock hole portions 127.

As shown in FIGS. 7 and 9, the cover member 14 is provided with the foregoing two protrusion portions 113. The two protrusion portions 113 include one protrusion portion 113 and the other protrusion portion 113.

The cover member 14 is fixed to the caliper body 51 by two fixing members 131 (FIG. 8 shows one of them). The two fixing members 131 are common components having the same shape. The fixing members 131 are screw members each having a head portion 132 and a screw shaft portion 133. The two fixing members 131 include one fixing member 131 and the other fixing member 131.

The head portion 132 has a circular shape and has a planar shape in which an end surface 135 on one side in the axis direction extends in an axially orthogonal direction. As shown in FIG. 3, a tool engagement groove 136 having a shape of a plus sign (+) is formed in the head portion 132. The tool engagement groove 136 is formed on the end surface 135 of the head portion 132 shown in FIG. 8 in a manner of being recessed in the axis direction of the head portion 132 from the end surface 135. In the head portion 132, an end surface 137 on a side opposite to the end surface 135 thereof in the axis direction has a tapered surface shape. The end surface 137 is separated from the end surface 135 in the axis direction of the head portion 132 as it goes toward the inward side in the radial direction thereof.

The screw shaft portion 133 extends in a manner of being separated from the head portion 132 in the axis direction of the head portion 132 from the end portion on the end surface 137 on a side opposite to the end surface 135 in the axis direction of the head portion 132. In the screw shaft portion 133, a male screw portion is formed in an outer circumferential portion.

The fixing members 131 are flat head screws.

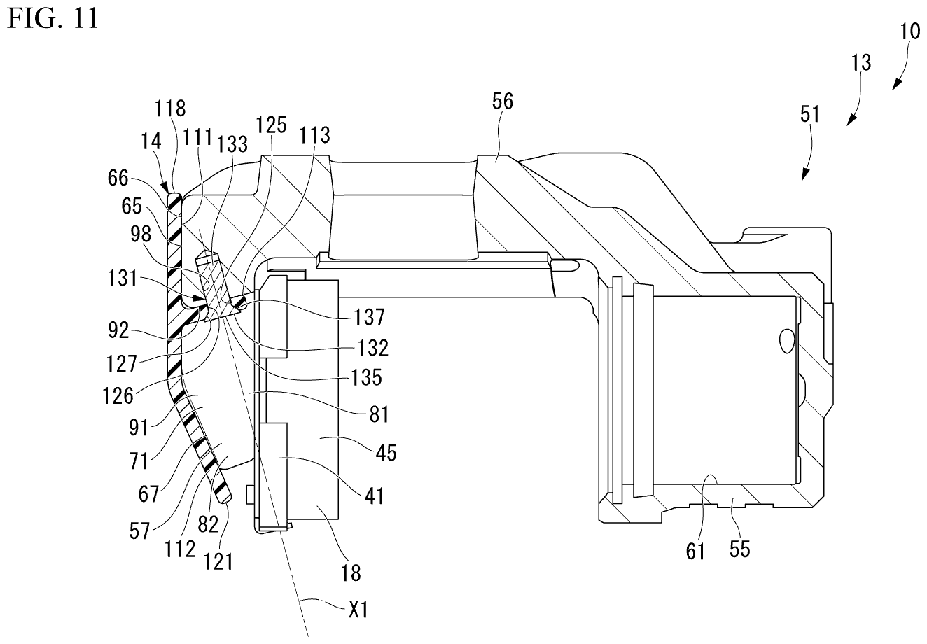

As shown in FIG. 11, the cover member 14 is disposed on a side of the facing portion 57 of the caliper body 51 opposite to the cylinder portions 55 in the disc axial direction. At this time, in the cover member 14, the first cover portion 111 positionally overlaps the main surface portion 66 of the caliper body 51 in the disc radial direction and the disc circumferential direction and abuts it in the disc axial direction in a surface contact manner. In addition, at this time, in the cover member 14, the second cover portion 112 positionally overlaps the inclined surface portion 67 of the caliper body 51 in the disc radial direction and the disc circumferential direction and faces it in the disc axial direction. In addition, at this time, in the cover member 14, the one protrusion portion 113 abuts the one bottom surface portion 92 of the caliper body 51 in a surface contact manner. In addition, at this time, in the cover member 14, the other protrusion portion 113 abuts the other bottom surface portion 92 of the caliper body 51 in a surface contact manner.

In this state, the one fixing member 131 of the pair of fixing members 131 is inserted through the fixing member insertion hole 125 of the one protrusion portion 113 of the cover member 14 in the screw shaft portion 133. Thereafter, this screw shaft portion 133 is screwed into the cover member fixing hole 98 opening in the one bottom surface portion 92 of the pair of bottom surface portions 92 of the caliper body 51 which this protrusion portion 113 abuts. Consequently, in this fixing member 131, the tapered end surface 137 thereof abuts the interlock hole portion 127 of this fixing member insertion hole 125 in a surface contact manner and presses and fixes this protrusion portion 113 to the caliper body 51. In other words, the one protrusion portion 113 is clamped between the one bottom surface portion 92 of the caliper body 51 and the end surface 137 of the one fixing member 131.

In addition, in this state, the other fixing member 131 is inserted through the fixing member insertion hole 125 of the other protrusion portion 113 of the cover member 14 in the screw shaft portion 133. Thereafter, this screw shaft portion 133 is screwed into the cover member fixing hole 98 opening in the other bottom surface portion 92 of the pair of bottom surface portions 92 of the caliper body 51 which this protrusion portion 113 abuts. Consequently, in this fixing member 131, the tapered end surface 137 thereof abuts the interlock hole portion 127 of this fixing member insertion hole 125 in a surface contact manner and presses and fixes this protrusion portion 113 to the caliper body 51. In other words, the other protrusion portion 113 is clamped between the other bottom surface portion 92 of the caliper body 51 and the end surface 137 of the other fixing member 131.

In this manner, the cover member 14 is fixed to the caliper body 51 by the two fixing members 131. In other words, the cover member 14 is fixed to the caliper 13 by the fixing members 131 engaging with the cover member fixing holes 98. Moreover, in other words, the fixing members 131 fix the cover member 14 to the caliper 13 by being fastened to the cover member fixing holes 98.

As shown in FIG. 1, the cover member 14 in a fixed state of being fixed to the caliper body 51 by the two fixing members 131 covers the pair of outer claws 71, the intermediate claw 72, and the pair of recessed portions 81 of the caliper body 51 shown in FIG. 5 from the side opposite to the cylinder portions 55 in the disc axial direction. In other words, as shown in FIG. 11, the cover member 14 is fixed to the caliper body 51 of the caliper 13 by the fixing members 131 engaging with the cover member fixing holes 98 and covers the recessed portions 81 in the disc axial direction. Since the cover member 14 in this fixed state covers the pair of recessed portions 81 of the caliper body 51 from the side opposite to the cylinder portions 55 in the disc axial direction, the appearance of the disc brake 10 is improved.

In the cover member 14 in this fixed state, the first cover portion 111 extends perpendicularly to the disc axis. In other words, the first cover portion 111 extends in the disc radial direction and the disc circumferential direction.

In the cover member 14 in this fixed state, the second cover portion 112 connected to the first cover portion 111 approaches the brake pad 18 in the disc axial direction as it goes toward the inward side in the disc radial direction. In other words, the second cover portion 112 is connected to the first cover portion 111 and extends such that a gap between the second cover portion 112 and the closer brake pad 18 of the pair of brake pads 17 and 18 decreases in the disc axial direction as it approaches the disc axis in the disc radial direction.

In the cover member 14 in this fixed state, the pair of protrusion portions 113 extend in a direction in which they approach the brake pad 18 in the disc axial direction from the first cover portion 111. In addition, in the cover member 14 in this fixed state, the pair of protrusion portions 113 extend perpendicularly to the radial reference plane and are positioned on the outward side in the disc radial direction as they approach the brake pad 18 in the disc axial direction.

In addition, in the cover member 14 in this fixed state, a gap between the end edge portion 121, which is the tip of the second cover portion 112 on the inward side in the disc radial direction, and the closer brake pad 18 of the pair of brake pads 17 and 18 in the disc axial direction is provided at a position farther away from the closer brake pad 18 of the pair of brake pads 17 and 18 than the virtual line X1 drawn in a direction in which the cover member fixing holes 98 extend.

An extension line of the center axis of the fixing member 131 for retaining the cover member 14 in this fixed state, that is, the virtual line X1 of the center axis of the cover member fixing hole 98 of the caliper 13 intersects the brake pad 18 of the pair of brake pads 17 and 18 closer to the cover member 14.

In the cover member 14 in this fixed state, an angle formed by the first cover portion 111 and the second cover portion 112 on a side facing the closer brake pad 18 of the pair of brake pads 17 and 18 in the disc axial direction is an obtuse angle.

In the cover member 14 in this fixed state, the length of the first cover portion 111 in the disc radial direction is longer than the length of the second cover portion 112 in the disc radial direction.

The cover member 14 in this fixed state has the protrusion portions 113 protruding toward the recessed portions 81 on a side facing the closer brake pad 18 of the pair of brake pads 17 and 18, and the protrusion portions 113 are fixed to the caliper body 51 by the fixing members 131.

In the cover member 14 in this fixed state, a gap between the end edge portion 121, which is the tip of the second cover portion 112 on the inward side in the disc radial direction, and the closer brake pad 18 of the pair of brake pads 17 and 18 in the disc axial direction is smaller than the diameters of the screw portions of the screw shaft portions 133 of the fixing members 131, that is, the screw outer diameters.

In the cover member 14 in this fixed state, the second cover portion 112 extends toward the closer brake pad 18 of the pair of brake pads 17 and 18 in the disc axial direction from the first cover portion 111, and covers the fixing member insertion holes 125 and the cover member fixing holes 98 when viewed in the disc radial direction. Specifically, in the cover member 14 in this fixed state, when viewed from the inside in the disc radial direction, the second cover portion 112 covers the cover member fixing holes 98 in their entirety and covers a part of the fixing member insertion holes 125. In the cover member 14 in this fixed state, when viewed from the inside in the disc radial direction, the second cover portion 112 covers the insertion hole portions 126 in their entirety.

In the caliper 13, the bottom surface portions 92 are inclined such that the distance to the disc axis increases as they approach the closer brake pad 18 of the pair of brake pads 17 and 18 in the disc axial direction.

In the cover member 14 in this fixed state, when viewed from the inside in the disc radial direction, as shown in FIG. 3, the second cover portion 112 covers at least a part of the tool engagement grooves 136 of the fixing members 131. Specifically, in the cover member 14 in this fixed state, when viewed from the inside in the disc radial direction, the second cover portion 112 covers the tool engagement grooves 136 including the center portions disposed on the center axes of the fixing members 131.

In the disc brake 10, a brake fluid is introduced into the two cylinder holes 61 of the cylinder portions 55 of the caliper 13 via brake piping (not shown). Consequently, in the two respective cylinder holes 61, the pressure of the brake fluid acts on the pistons 62. As a result, both the pistons 62 move forward to the disc 11 side and press the brake pad 17 on the inner side disposed between the pistons 62 and the disc 11 toward the disc 11. Accordingly, this brake pad 17 moves in the disc axial direction and comes into contact with a surface 11 of the disc 11. In other words, the pistons 62 for moving the brake pad 17 on the inner side are disposed in the cylinder holes 61 of the cylinder portions 55.

Due to the reaction force of pressure applied by the pistons 62, the caliper body 51 causes the slide pins 47 to slide with respect to the attachment member 12 and moves in the disc axial direction, and the facing portion 57 presses the brake pad 18 on the outer side disposed between the facing portion 57 and the disc 11 toward the disc 11. Accordingly, this brake pad 18 moves in the disc axial direction and comes into contact with the surface 11b of the disc 11. That is, the pair of brake pads 17 and 18 supported by the attachment member 12 via the pair of pad springs 15 are pressed against the disc 11 by the caliper 13.

In this manner, due to actuation of the plurality of pistons 62, the caliper 13 clamps the brake pads 17 and 18 from both sides between the pistons 62 and the facing portion 57 and presses them against both the surfaces 11a and 11b of the disc 11. As a result, the caliper 13 generates a braking force by applying a frictional resistance to the disc 11. The caliper 13 is a floating-type caliper, and it is a fist-type caliper.

Patent Document 1 discloses a disc brake equipped with a cover member in a part of a caliper which can be seen when viewed from outside a vehicle. In disc brakes of this kind, in a state of being attached to a vehicle, there is a probability that the cover member will be removed from the caliper, for example, by inserting a tool through a gap part in a wheel. For example, in the disc brake described in Patent Document 1, there is a probability that the fixed state by a fixing member will be able to be cancelled by inserting a tool through a gap between the cover member and a brake pad on a side closer to the cover member and engaging the tool with the fixing member.

In the disc brake 10 of the first embodiment, the cover member 14 covering the recessed portions 81 in the disc axial direction is fixed to the caliper 13 by the fixing members 131. The cover member fixing holes 98 of the caliper 13 with which the fixing members 131 engage are formed in the inner circumferences of the recessed portions 81 in a manner of being inclined with respect to the disc radial direction. Thus, it is possible to make it difficult for a tool to engage with the fixing members 131 engaging with the cover member fixing holes 98. Therefore, the disc brake 10 is enabled to curb removal of the cover member 14 in a state of being attached to a vehicle.

In the disc brake 10, the first cover portion 111 of the cover member 14 extends in the disc radial direction and the disc circumferential direction. The second cover portion 112 connected to the first cover portion 111 extends such that the gap between the second cover portion 112 and the closer brake pad 18 of the pair of brake pads 17 and 18 decreases in the disc axial direction as it approaches the disc axis in the disc radial direction. Thus, it becomes difficult for a tool to be inserted into the disc brake 10 through the gap between the cover member 14 and the brake pad 18 and engage with the fixing members 131. Therefore, the disc brake 10 is enabled to further curb removal of the cover member 14 in a state of being attached to a vehicle.

In the disc brake 10, a gap between the end edge portion 121, which is the tip of the second cover portion 112 on the inward side in the disc radial direction, and the brake pad 18 of the pair of brake pads 17 and 18 closer to the end edge portion 121 in the disc axial direction is provided at a position farther away from the brake pad 18 than the virtual line X1 drawn in a direction in which the cover member fixing holes 98 extend. Thus, it becomes difficult for a tool to be inserted into the disc brake 10 through the gap between the cover member 14 and the brake pad 18 and engage with the fixing members 131. Therefore, the disc brake 10 is enabled to further curb removal of the cover member 14 in a state of being attached to a vehicle.

In the cover member 14 of the disc brake 10, an angle formed by the first cover portion 111 and the second cover portion 112 on a side facing the brake pad 18 of the pair of brake pads 17 and 18 closer to the cover member 14 in the disc axial direction is an obtuse angle. Thus, the gap can be narrowed by bringing the second cover portion 112 closer to the brake pad 18 in the disc axial direction while it is extended to the inward side in the disc radial direction from the first cover portion 111. Thus, it becomes difficult for a tool to be inserted into the disc brake 10 through the gap between the cover member 14 and the brake pad 18 and engage with the fixing members 131. Therefore, the disc brake 10 is enabled to further curb removal of the cover member 14 in a state of being attached to a vehicle.

In the cover member 14 of the disc brake 10, the length of the first cover portion 111 in the disc radial direction is longer than the length of the second cover portion 112 in the disc radial direction. Thus, design of the cover member 14 can be improved.

In the disc brake 10, the cover member 14 has the protrusion portions 113 protruding toward the recessed portions 81 on a side facing the closer brake pad 18 of the pair of brake pads 17 and 18. In the cover member 14, the protrusion portions 113 are fixed to the caliper 13 by the fixing members 131. Thus, at the time of assembling the disc brake 10, the cover member 14 can be easily attached to the caliper body 51 by the fixing members 131.

In the disc brake 10, the fixing members 131 are screw members. For this reason, since the cover member fixing holes 98 of the caliper 13 are formed in a manner of being inclined with respect to the disc radial direction, it is possible to make it difficult for a tool to engage with the fixing members 131 engaging with the cover member fixing holes 98 and to rotate in the engaged state. Therefore, the disc brake 10 is enabled to further curb removal of the cover member 14 in a state of being attached to a vehicle.

In the disc brake 10, the fixing members 131 are flat head screws. For this reason, since the cover member fixing holes 98 of the caliper 13 are formed in a manner of being inclined with respect to the disc radial direction, it is possible to make it difficult for a tool to engage with the fixing members 131 engaging with the cover member fixing holes 98 and to rotate in the engaged state. Therefore, the disc brake 10 is enabled to further curb removal of the cover member 14 in a state of being attached to a vehicle.

In the disc brake 10, a gap between the end edge portion 121 of the cover member 14, which is the tip of the second cover portion 112 on the inward side in the disc radial direction, and the closer brake pad 18 of the pair of brake pads 17 and 18 in the disc axial direction is smaller than the diameters of the screw portions of the fixing members 131. Thus, it becomes difficult to insert a tool having a suitable size with a diameter equivalent to the diameters of the screw portions through a gap between the end edge portion 121 of the cover member 14 and the brake pad 18. Therefore, the disc brake 10 is enabled to further curb removal of the cover member 14 in a state of being attached to a vehicle.

In the disc brake 10, the bottom surface portions 92 of the caliper 13 are inclined such that the distance to the disc axis increases as they approach the closer brake pad 18 of the pair of brake pads 17 and 18 in the disc axial direction. Thus, it is easy to perform machining when forming the cover member fixing holes 98 in the caliper 13 in a manner of being inclined with respect to the disc radial direction.

In the disc brake 10, the second cover portion 112 of the cover member 14 extends toward the closer brake pad 18 of the pair of brake pads 17 and 18 in the disc axial direction from the first cover portion 111, and covers the cover member fixing holes 98 engaged with the fixing members 131 when viewed from the inside in the disc radial direction. Thus, it becomes difficult for a tool to be inserted into the disc brake 10 through the gap between the cover member 14 and the brake pad 18 and engage with the fixing members 131. Therefore, the disc brake 10 is enabled to curb removal of the cover member 14 in a state of being attached to a vehicle.

### Second Embodiment

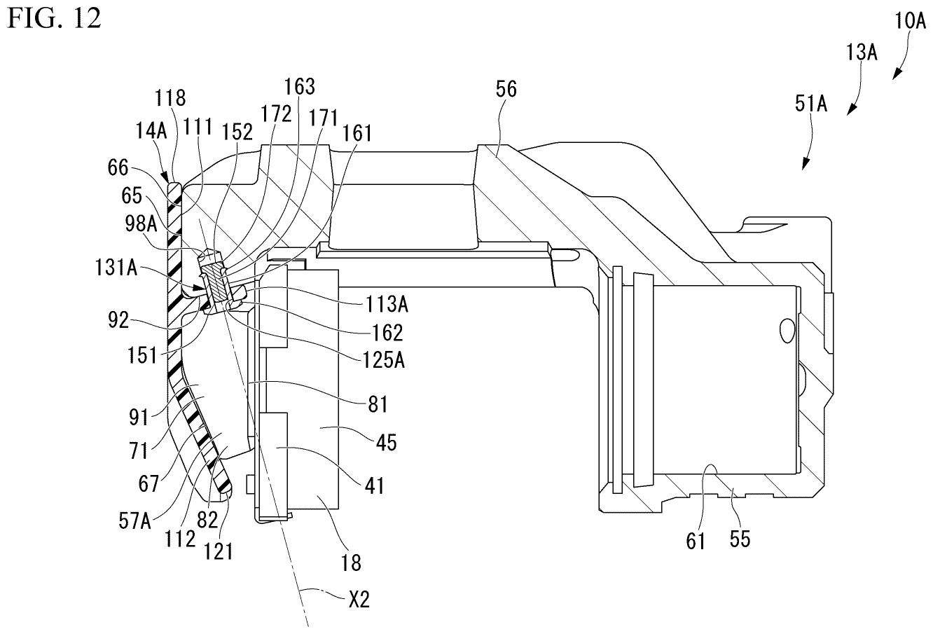

Next, a second embodiment will be described mainly with reference to FIG. 12, focusing on parts different from those of the first embodiment. Parts common to those of the first embodiment will be expressed by the same names and the same reference signs.

In a disc brake 10A of the second embodiment, a caliper 13A which is partially different from the caliper 13 is used in place of the caliper 13. In the caliper 13A, a caliper body 51A which is partially different from the caliper body 51 is used in place of the caliper body 51. In the caliper body 51A, a facing portion 57A which is partially different from the facing portion 57 is formed in place of the facing portion 57. The facing portion 57A differs from the facing portion 57 in that cover member fixing holes 98A which are partially different from the cover member fixing holes 98 are formed in place of the cover member fixing holes 98. The cover member fixing holes 98A are formed perpendicularly to the bottom surface portions 92 from center positions in the bottom surface portions 92 of the recessed portions 81 in the disc circumferential direction and intermediate positions in the disc axial direction. The cover member fixing holes 98A are not screw holes but straight holes having a cylinder surface-shaped inner circumferential surface. A virtual line X2 drawn in a direction in which the cover member fixing holes 98 extend does not pass through the outer claws 71 and the intermediate claw 72 (refer to FIGS. 5 to 7). In the facing portion 57A, the cover member fixing holes 98A are formed at positions in the respective bottom surface portions 92 of the two recessed portions 81 (not shown).

In the disc brake 10A, a cover member 14A which is partially different from the cover member 14 is used in place of the cover member 14. In the cover member 14A, protrusion portions 113A which are partially different from the protrusion portions 113 are formed in place of the protrusion portions 113. The two protrusion portions 113A are formed in the cover member 14A in place of the two protrusion portions 113 (not shown). The protrusion portions 113A differ from the protrusion portions 113 in that fixing member insertion holes 125A which are partially different from the fixing member insertion holes 125 are formed in place of the fixing member insertion holes 125. The fixing member insertion holes 125A are straight holes having a cylinder surface-shaped inner circumferential surface throughout the overall length in the axial direction.

In the disc brake 10A, fixing members 131A different from the fixing members 131 are used in place of the fixing members 131. In the disc brake 10A, the two fixing members 131A are used in place of the two fixing members 131 (not shown). The fixing members 131A are blind hole fastening-type blind rivets. The fixing members 131A each have a tubular member 151 and a shaft-shaped member 152.

The tubular member 151 has a cylindrical main body portion 161, a flange portion 162 extending outward in the radial direction of a main body portion 161 from one end of the main body portion 161 in the axial direction, and an intrusion portion 163 protruding outward in the radial direction of the main body portion 161 from the other end of the main body portion 161 in the axial direction and intruding into the inner circumferential portion of the fixing member insertion hole 125A.

The shaft-shaped member 152 has a columnar main shaft portion 171, and a flange portion 172 extending outward in the radial direction of the main shaft portion 171 from one end of the main shaft portion 171 in the axial direction.

The cover member 14A is disposed on a side of the facing portion 57A of the caliper body 51A opposite to the cylinder portions 55 in the disc axial direction. At this time, in the cover member 14A, the first cover portion 111 and the second cover portion 112 are disposed similarly to those of the first embodiment with respect to the end surface 65 of the caliper body 51A. Along with this, in the cover member 14A, the protrusion portions 113A abut the bottom surface portions 92 of the caliper body 51A in a surface contact manner. In the cover member 14A, the two protrusion portions 113A respectively abut the corresponding bottom surface portions 92 of the caliper body 51A in a surface contact manner (not shown).

Here, in the fixing member 131A in a state before being attached to the cover member fixing hole 98A of the caliper body 51A, the intrusion portion 163 is not formed in the tubular member 151. In addition, in the shaft-shaped member 152, the main shaft portion 171 is inserted into the main body portion 161 of the tubular member 151, and the flange portion 172 faces the end portion of the main body portion 161 on a side opposite to the flange portion 162 in the axial direction. In the shaft-shaped member 152, the main shaft portion 171 is a base member having a longer shape to a side opposite to the flange portion 172 in the axial direction. In this base member, a weak portion which is weaker than other parts is formed at a predetermined position in the axial direction.

In the fixing member 131A in such a state, until the flange portion 162 abuts the protrusion portion 113A of the cover member 14A, the main body portion 161 of the tubular member 151 is inserted through the fixing member insertion hole 125A of the protrusion portion 113A and is fitted into the cover member fixing hole 98A of the caliper body 51A. Further, while maintaining a state in which the flange portion 162 of the tubular member 151 abuts the protrusion portion 113A, the base member of the shaft-shaped member 152 is moved in a direction in which it is pulled out from the tubular member 151. Consequently, in the base member of the shaft-shaped member 152, the flange portion 172 crimps the main body portion 161 of the tubular member 151 such that it is plastically deformed and intrudes into the inner circumferential portion of the cover member fixing hole 98A to form the intrusion portion 163. Thereafter, the base member of the shaft-shaped member 152 breaks in the weak portion and forms the shaft-shaped member 152 in a state of remaining inside the tubular member 151. Accordingly, the fixing member 131A is fixed to the caliper body 51A, and the cover member 14A is fixed to the caliper body 51A. In other words, the cover member 14A is fixed to the caliper 13A by the fixing members 131A engaging with the cover member fixing holes 98A. In the disc brake 10A, the two fixing members 131A are respectively fixed to the corresponding cover member fixing holes 98A of the caliper body 51A and fix the corresponding protrusion portions 113A of the cover member 14A to the caliper body 51A (not shown).

In the cover member 14A in a fixed state of being fixed to the caliper body 51A by the fixing members 131A, the first cover portion 111 and the second cover portion 112 are disposed similarly to the first cover portion 111 and the second cover portion 112 of the first embodiment with respect to the end surface 65 of the caliper body 51A, the disc 11 (refer to FIG. 3), and the brake pad 18.

In the cover member 14A in this fixed state, a gap between the end edge portion 121, which is the tip of the second cover portion 112 on the inward side in the disc radial direction, and the brake pad 18 in the disc axial direction is smaller than the outer diameters of the flange portions 162 of the fixing members 131A.

In the cover member 14A in this fixed state, a gap between the end edge portion 121, which is the tip of the second cover portion 112 on the inward side in the disc radial direction, and the brake pad 18 in the disc axial direction is provided at a position farther away from the brake pad 18 than the virtual line X2 drawn in a direction in which the cover member fixing holes 98A extend.

An extension line of the center axis of the fixing member 131A for retaining the cover member 14A in this fixed state, that is, the virtual line X2 of the center axis of the cover member fixing hole 98A of the caliper 13A intersects the brake pad 18.

The cover member 14A in this fixed state covers the fixing member insertion hole 125A and the cover member fixing holes 98A when viewed in the disc radial direction. Specifically, in the cover member 14A in this fixed state, when viewed from the inside in the disc radial direction, the second cover portion 112 covers the cover member fixing holes 98A in their entirety and covers the fixing member insertion holes 125A in their entirety.

In the disc brake 10A of the second embodiment, the cover member fixing holes 98A of the caliper 13A with which the fixing members 131A engage are formed in the inner circumferences of the recessed portions 81 in a manner of being inclined with respect to the disc radial direction. Thus, it is possible to make it difficult for a tool to engage with the fixing members 131A engaging with the cover member fixing holes 98A. Therefore, the disc brake 10A is enabled to curb removal of the cover member 14A in a state of being attached to a vehicle.

In the disc brake 10A, a gap between the end edge portion 121, which is the tip of the second cover portion 112 on the inward side in the disc radial direction, and the brake pad 18 in the disc axial direction is provided at a position farther away from the brake pad 18 than the virtual line X2 drawn in a direction in which the cover member fixing holes 98A extend. Thus, it becomes difficult for a tool to be inserted into the disc brake 10A through the gap between the cover member 14A and the brake pad 18 and engage with the fixing members 131A. Therefore, the disc brake 10A is enabled to further curb removal of the cover member 14A in a state of being attached to a vehicle.

In the disc brake 10A, the fixing members 131A are rivet members fixing the cover member 14A to the caliper 13A by being crimped into the cover member fixing holes 98A. Thus, the disc brake 10A is enabled to further curb removal of the cover member 14A in a state of being attached to a vehicle.

In the disc brake 10A, the second cover portion 112 of the cover member 14A extends toward the brake pad 18 in the disc axial direction from the first cover portion 111, and covers the cover member fixing holes 98A engaged with the fixing members 131A when viewed from the inside in the disc radial direction. Thus, it becomes difficult for a tool to be inserted into the disc brake 10A through the gap between the cover member 14A and the brake pad 18 and engage with the fixing members 131A. Therefore, the disc brake 10A is enabled to curb removal of the cover member 14A in a state of being attached to a vehicle.

### Third Embodiment

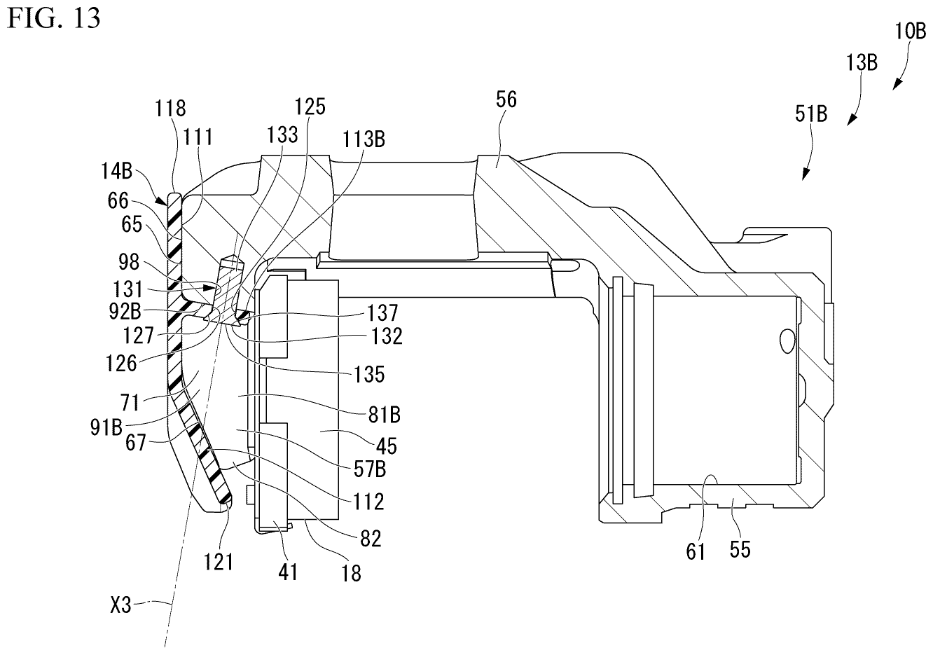

Next, a third embodiment will be described mainly with reference to FIG. 13, focusing on parts different from those of the first embodiment. Parts common to those of the first embodiment will be expressed by the same names and the same reference signs.

In a disc brake 10B of the third embodiment, a caliper 13B which is partially different from the caliper 13 is used in place of the caliper 13. In the caliper 13B, a caliper body 51B which is partially different from the caliper body 51 is used in place of the caliper body 51. In the caliper body 51B, a facing portion 57B which is partially different from the facing portion 57 is formed in place of the facing portion 57. In the facing portion 57B, recessed portions 81B which are partially different from the recessed portions 81 are formed in place of the recessed portions 81. Two recessed portions 81B are formed in the facing portion 57B in a mirror symmetrical shape in place of the two recessed portions 81 (not shown). The recessed portions 81B differ from the recessed portions 81 in that an inner circumferential surface 91B which is partially different from the inner circumferential surface 91 is formed in place of the inner circumferential surface 91. In the inner circumferential surface 91B, bottom surface portions 92B (recessed bottom surface portions) which are partially different from the bottom surface portions 92 are formed in place of the bottom surface portions 92.

The bottom surface portions 92B are formed in center portions of the recessed portions 81B in the disc circumferential direction. The bottom surface portions 92B are provided at positions in the recessed portions 81B facing the opening portions 82 in the disc radial direction. The bottom surface portions 92B are provided at positions in the end portions of the recessed portions 81B on a side opposite to the opening portions 82 in a direction in which the radial reference line extends. The bottom surface portions 92B have a planar shape. The bottom surface portions 92B extend perpendicularly to the radial reference line when viewed in the disc axial direction. When viewed in the disc circumferential direction, the bottom surface portions 92B extend in a manner of being positioned on the inward side in the disc radial direction as they approach the cylinder portions 55 in the disc axial direction. Thus, the bottom surface portions 92B extend perpendicularly to the radial reference plane and extend in a manner of being positioned on the inward side in the disc radial direction as they approach the cylinder portions 55 in the disc axial direction.

The caliper body 51B is provided with two recessed portions 81B having the foregoing shape side by side in the disc circumferential direction. In the two recessed portions 81B, the respective bottom surface portions 92B are disposed in the same plane.

In the caliper body 51B, the cover member fixing holes 98 similar to those of the first embodiment are formed perpendicularly to the bottom surface portions 92B at positions in the bottom surface portions 92B of the recessed portions 81B. In the facing portion 57B, the cover member fixing holes 98 are formed at positions in the respective bottom surface portions 92B of the two recessed portions 81B (not shown).

The cover member fixing holes 98 are formed in a manner of opening at center positions in the bottom surface portions 92B in the disc circumferential direction and intermediate positions in the disc axial direction. The cover member fixing holes 98 extend parallel to the radial reference line when viewed in the disc axial direction. When viewed in the disc circumferential direction, the cover member fixing holes 98 extend in a manner of being separated from the cylinder portions 55 in the disc axial direction as they go toward the inward side in the disc radial direction. Thus, the cover member fixing holes 98 are provided in the inner circumferences of the recessed portions 81B and are formed in a manner of being inclined with respect to the disc radial direction. A virtual line X3 drawn in a direction in which the cover member fixing holes 98 extend does not pass through the outer claws 71 and the intermediate claw 72 (refer to FIGS. 5 to 7).

In the disc brake 10B, a cover member 14B which is partially different from the cover member 14 is used in place of the cover member 14. In the cover member 14B, protrusion portions 113B which are partially different from the protrusion portions 113 are formed in place of the protrusion portions 113. The two protrusion portions 113B are formed in the cover member 14B in place of the two protrusion portions 113 (not shown).

The protrusion portions 113B have a plate shape protruding to one side of the first cover portion 111 in the thickness direction from the first cover portion 111. The protrusion portions 113B protrude from the first cover portion 111 to the same side as that in a direction in which the second cover portion 112 is inclined. The protrusion portions 113B extend in a direction in which the end edge portions 118 and 121 extend.

The protrusion portions 113B are inclined with respect to the thickness direction of the first cover portion 111 in a manner of approaching the second cover portion 112 in a direction in which the pair of end edge portions 119 of the first cover portion 111 (refer to FIG. 7) extend as they protrude to one side of the first cover portion 111 in the thickness direction from the first cover portion 111.

In the protrusion portions 113B, the fixing member insertion holes 125 similar to those of the first embodiment are formed perpendicularly to the thickness direction. Thus, the fixing member insertion holes 125 are inclined with respect to the first cover portion 111 in a manner of approaching the first cover portion 111 in the thickness direction of the first cover portion 111 as they approach the second cover portion 112 in a direction in which the pair of end edge portions 119 of the first cover portion 111 (refer to FIG. 7) extend.

The second cover portion 112 extends from the first cover portion 111 to a position overlapping the fixing member insertion holes 125 in the thickness direction of the first cover portion 111. The second cover portion 112 overlaps the insertion hole portions 126 in their entirety in the thickness direction of the first cover portion 111 and overlaps a part on the first cover portion 111 side including the center axes of the interlock hole portions 127.

The cover member 14B is disposed on a side of the facing portion 57B of the caliper body 51B opposite to the cylinder portions 55 in the disc axial direction. At this time, in the cover member 14B, the first cover portion 111 and the second cover portion 112 are disposed similarly to those of the first embodiment with respect to the end surface 65 of the caliper body 51B, and the protrusion portions 113B abut the bottom surface portions 92B of the caliper body 51B in a surface contact manner. In the cover member 14B, the two protrusion portions 113B respectively abut the corresponding bottom surface portions 92B in a surface contact manner (not shown).

In this state, in the fixing member 131, the screw shaft portion 133 is inserted through the fixing member insertion hole 125 of the protrusion portion 113B of the cover member 14B and is screwed into the cover member fixing hole 98 opening in the bottom surface portion 92B of the caliper body 51B. Consequently, in this fixing member 131, the tapered end surface 137 thereof abuts the interlock hole portion 127 of this fixing member insertion hole 125 and presses and fixes this protrusion portion 113B to the caliper body 51B. In other words, the protrusion portion 113B is clamped between the bottom surface portion 92B of the caliper body 51B and the end surface 137 of the fixing member 131.

In this manner, the cover member 14B is fixed to the caliper body 51B by the fixing members 131. In other words, the cover member 14B is fixed to the caliper 13B by the fixing members 131 engaging with the cover member fixing holes 98. Moreover, in other words, the fixing members 131 fix the cover member 14B to the caliper 13B by being fastened to the cover member fixing holes 98. In the disc brake 10B, the two fixing members 131 are respectively are fixed to the corresponding cover member fixing holes 98 of the caliper body 51B and fix the corresponding protrusion portions 113B of the cover member 14B to the caliper body 51B (not shown).

In the cover member 14B in a fixed state of being fixed to the caliper body 51B by the fixing members 131, the first cover portion 111 and the second cover portion 112 are disposed similarly to the first cover portion 111 and the second cover portion 112 of the first embodiment with respect to the end surface 65 of the caliper body 51B, the disc 11 (refer to FIG. 3), and the brake pad 18.

In the cover member 14B in this fixed state, the protrusion portions 113B extend in a direction in which they approach the brake pad 18 in the disc axial direction from the first cover portion 111. In addition, in the cover member 14B in this fixed state, the protrusion portions 113B extend perpendicularly to the radial reference plane and are positioned on the inward side in the disc radial direction as they approach the brake pad 18 in the disc axial direction.

In the cover member 14B in this fixed state, a gap between the end edge portion 121, which is the tip of the second cover portion 112 on the inward side in the disc radial direction, and the brake pad 18 in the disc axial direction is provided at a position farther away from the second cover portion 112 than the virtual line X3 drawn in a direction in which the cover member fixing holes 98 extend.

The cover member fixing holes 98 of the caliper body 51B are inclined with respect to the disc radial direction toward the first cover portion 111 extending in the disc radial direction of the cover member 14B in this fixed state.

An extension line of the center axis of the fixing member 131 for retaining the cover member 14B in a fixed state, that is, the virtual line X3 of the center axis of the cover member fixing hole 98 of the caliper 13B intersects the second cover portion 112.

The cover member 14B in this fixed state has the protrusion portions 113B protruding toward the recessed portions 81 on a side facing the brake pad 18. The protrusion portions 113B are fixed to the caliper body 51B by the fixing members 131.

In the cover member 14B in this fixed state, a gap between the end edge portion 121, which is the tip of the second cover portion 112 on the inward side in the disc radial direction, and the brake pad 18 in the disc axial direction is smaller than the diameters of the screw portions of the screw shaft portions 133 of the fixing members 131, that is, the screw outer diameters.

In the cover member 14B in this fixed state, the second cover portion 112 extends toward the brake pad 18 in the disc axial direction from the first cover portion 111 and covers the fixing member insertion holes 125 and the cover member fixing holes 98 when viewed in the disc radial direction. Specifically, in the cover member 14B in this fixed state, when viewed from the inside in the disc radial direction, the second cover portion 112 covers the cover member fixing holes 98 in their entirety and covers a part of the fixing member insertion holes 125. In the cover member 14B in this fixed state, when viewed from the inside in the disc radial direction, the second cover portion 112 covers the insertion hole portions 126 in their entirety.

In the caliper 13B, the bottom surface portions 92B are inclined such that the distance to the disc axis is shortened as they approach the brake pad 18 in the disc axial direction.

In the cover member 14B in this fixed state, when viewed from the inside in the disc radial direction, the second cover portion 112 covers at least a part of the tool engagement grooves 136 of the fixing members 131 (refer to FIG. 4). Specifically, in the cover member 14B in this fixed state, when viewed from the inside in the disc radial direction, the second cover portion 112 covers the tool engagement grooves 136 (refer to FIG. 4) including the center portions disposed on the center axes of the fixing members 131.

In the disc brake 10B of the third embodiment, the cover member fixing holes 98 of the caliper 13B with which the fixing members 131 engage are formed in the inner circumferences of the recessed portions 81B in a manner of being inclined with respect to the disc radial direction. Thus, it is possible to make it difficult for a tool to engage with the fixing members 131 engaging with the cover member fixing holes 98. Therefore, the disc brake 10B is enabled to curb removal of the cover member 14B in a state of being attached to a vehicle.

In the disc brake 10B, a gap between the end edge portion 121, which is the tip of the second cover portion 112 on the inward side in the disc radial direction, and the brake pad 18 in the disc axial direction is provided at a position farther away from the second cover portion 112 than the virtual line X3 drawn in a direction in which the cover member fixing holes 98 extend. Thus, it becomes difficult for a tool to be inserted into the disc brake 10B through the gap between the cover member 14B and the brake pad 18 and engage with the fixing members 131. Therefore, the disc brake 10B is enabled to further curb removal of the cover member 14B in a state of being attached to a vehicle.

In the disc brake 10B, the cover member 14B has the protrusion portions 113B protruding toward the recessed portions 81 on a side facing the brake pad 18. Further, in the cover member 14B, the protrusion portions 113B are fixed to the caliper 13B by the fixing members 131. Thus, at the time of assembling the disc brake 10B, the cover member 14B can be easily attached to the caliper body 51B by the fixing members 131.

In the disc brake 10B, the cover member fixing holes 98 of the caliper body 51B are inclined with respect to the disc radial direction toward the first cover portion 111 extending in the disc radial direction of the cover member 14B. Thus, it becomes difficult for a tool to be inserted into the disc brake 10 through the gap between the cover member 14B and the brake pad 18 and engage with the fixing members 131. Therefore, the disc brake 10B is enabled to further curb removal of the cover member 14B in a state of being attached to a vehicle.

In the disc brake 10B, the bottom surface portions 92B of the caliper 13B are inclined such that the distance to the disc axis is shortened as they approach the brake pad 18 in the disc axial direction. Thus, it is easy to perform machining when forming the cover member fixing holes 98 in the caliper 13B in a manner of being inclined with respect to the disc radial direction.

In the disc brake 10B, the second cover portion 112 of the cover member 14B extends toward the brake pad 18 in the disc axial direction from the first cover portion 111, and covers the cover member fixing holes 98 engaged with the fixing members 131 when viewed from the inside in the disc radial direction. Thus, it becomes difficult for a tool to be inserted into the disc brake 10B through the gap between the cover member 14B and the brake pad 18 and engage with the fixing members 131. Therefore, the disc brake 10B is enabled to curb removal of the cover member 14B in a state of being attached to a vehicle.

In the disc brake 10B of the third embodiment, in place of the fixing structure constituted of the cover member fixing holes 98, the fixing member insertion hole 125, and the fixing members 131 for the cover member 14B with respect to the caliper body 51B, a fixing structure constituted of the cover member fixing holes 98A, the fixing member insertion hole 125A, and the fixing members 131A of the second embodiment can also be employed.

### Fourth Embodiment

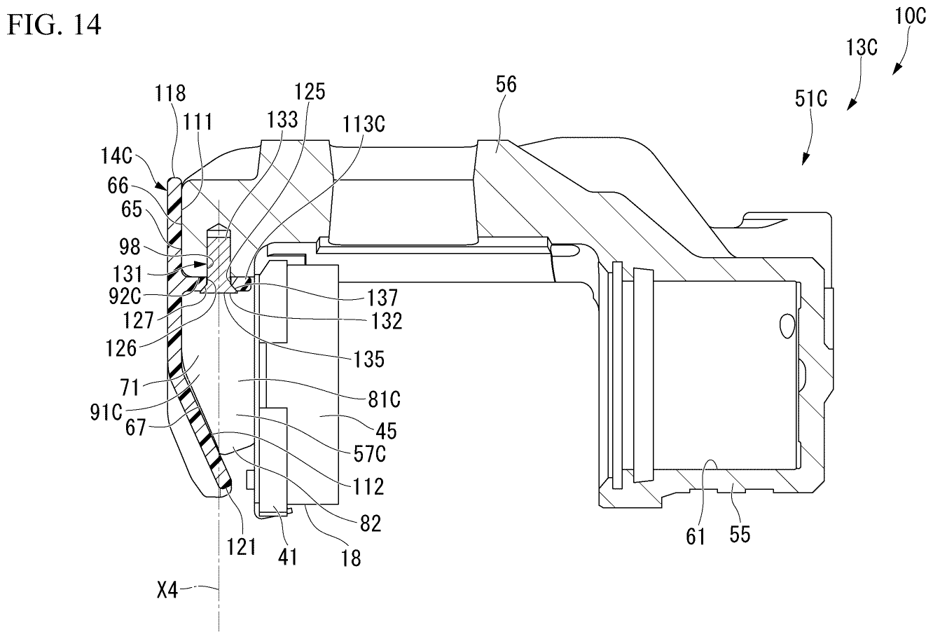

Next, a fourth embodiment will be described mainly with reference to FIG. 14, focusing on parts different from those of the first embodiment. Parts common to those of the first embodiment will be expressed by the same names and the same reference signs.

In a disc brake 10C of the fourth embodiment, a caliper 13C which is partially different from the caliper 13 is used in place of the caliper 13. In the caliper 13C, a caliper body 51C which is partially different from the caliper body 51 is used in place of the caliper body 51. In the caliper body 51C, a facing portion 57C which is partially different from the facing portion 57 is formed in place of the facing portion 57. In the facing portion 57C, recessed portions 81C which are partially different from the recessed portions 81 are formed in place of the recessed portions 81. Two recessed portions 81C are formed in the facing portion 57C in a mirror symmetrical shape in place of the two recessed portions 81 (not shown). The recessed portions 81C differ from the recessed portions 81 in that an inner circumferential surface 91C which is partially different from the inner circumferential surface 91 is formed in place of the inner circumferential surface 91. In the inner circumferential surface 91C, bottom surface portions 92C (recessed bottom surface portions) which are partially different from the bottom surface portions 92 are formed in place of the bottom surface portions 92.

The bottom surface portions 92C are formed in center portions of the recessed portions 81C in the disc circumferential direction. The bottom surface portions 92C are provided at positions in the recessed portions 81C facing the opening portions 82 in the disc radial direction. The bottom surface portions 92C are provided at positions in the end portions of the recessed portions 81C on a side opposite to the opening portions 82 in a direction in which the radial reference line extends. The bottom surface portions 92C have a planar shape. The bottom surface portions 92C extend perpendicularly to the radial reference line when viewed in the disc axial direction. When viewed in the disc circumferential direction, the bottom surface portions 92C extend parallel to the disc axial direction. Thus, the bottom surface portions 92C extend perpendicularly to the radial reference line.

The caliper body 51C is provided with two recessed portions 81C having the foregoing shape side by side in the disc circumferential direction. In the two recessed portions 81C, each of the bottom surface portions 92C is disposed in the same plane.

In the caliper body 51C, the cover member fixing holes 98 similar to those of the first embodiment are formed perpendicularly to the bottom surface portions 92C at positions in the bottom surface portions 92C of the recessed portions 81C. In the facing portion 57C, the cover member fixing holes 98 are formed at positions in the respective bottom surface portions 92C of the two recessed portions 81C (not shown).

The cover member fixing holes 98 are formed in a manner of opening at center positions in the bottom surface portions 92C in the disc circumferential direction and intermediate positions in the disc axial direction. The cover member fixing holes 98 extend parallel to the radial reference line when viewed in the disc axial direction. The cover member fixing holes 98 extend perpendicularly to the disc axis when viewed in the disc circumferential direction. Thus, the cover member fixing holes 98 are provided in the inner circumferences of the recessed portions 81C and are formed in the disc radial direction. A virtual line X4 drawn in a direction in which the cover member fixing holes 98 extend does not pass through the outer claws 71 and the intermediate claw 72.

In the disc brake 10C, a cover member 14C which is partially different from the cover member 14 is used in place of the cover member 14. In the cover member 14C, protrusion portions 113C which are partially different from the protrusion portions 113 are formed in place of the protrusion portions 113. The two protrusion portions 113C are formed in the cover member 14C in place of the two protrusion portions 113 (not shown).

The protrusion portions 113C have a plate shape protruding to one side of the first cover portion 111 in the thickness direction from the first cover portion 111. The protrusion portions 113C protrude from the first cover portion 111 to the same side as that in a direction in which the second cover portion 112 is inclined. The protrusion portions 113C extend in a direction in which the end edge portions 118 and 121 extend.

The protrusion portions 113C protrude from the first cover portion 111 to one side in the thickness direction of the first cover portion 111 perpendicularly to the first cover portion 111.

In the protrusion portions 113C, the fixing member insertion holes 125 similar to those of the first embodiment are formed perpendicularly to the thickness direction of the protrusion portions 113C. Thus, the fixing member insertion holes 125 lie in a direction in which the pair of end edge portions 119 of the first cover portion 111 (refer to FIG. 7) extend. The fixing member insertion holes 125 are formed parallel to the first cover portion 111.

The second cover portion 112 extends from the first cover portion 111 to a position overlapping the fixing member insertion holes 125 in the thickness direction of the first cover portion 111. The second cover portion 112 overlaps the insertion hole portions 126 in their entirety in the thickness direction of the first cover portion 111 and overlaps a part on the first cover portion 111 side including the center axes of the interlock hole portions 127.

The cover member 14C is disposed on a side of the facing portion 57C of the caliper body 51C opposite to the cylinder portions 55 in the disc axial direction. At this time, in the cover member 14C, the first cover portion 111 and the second cover portion 112 are disposed similarly to those of the first embodiment with respect to the end surface 65 of the caliper body 51C, and the protrusion portions 113C abut the bottom surface portions 92C of the caliper body 51C in a surface contact manner. In the cover member 14C, the two protrusion portions 113C respectively abut the corresponding bottom surface portions 92C in a surface contact manner (not shown).

In this state, in the fixing member 131, the screw shaft portion 133 is inserted through the fixing member insertion hole 125 of the protrusion portion 113C of the cover member 14C and is screwed into the cover member fixing hole 98 opening in the bottom surface portion 92C of the caliper body 51C. Consequently, in this fixing member 131, the tapered end surface 137 thereof abuts the interlock hole portion 127 of this fixing member insertion hole 125 and presses and fixes this protrusion portion 113C to the caliper body 51C. In other words, the protrusion portion 113C is clamped between the bottom surface portion 92C of the caliper body 51C and the end surface 137 of the fixing member 131.

In this manner, the cover member 14C is fixed to the caliper body 51C by the fixing members 131. In other words, the cover member 14C is fixed to the caliper 13C by the fixing members 131 engaging with the cover member fixing holes 98. Moreover, in other words, the fixing members 131 fix the cover member 14C to the caliper 13C by being fastened to the cover member fixing holes 98. In the disc brake 10C, the two fixing members 131 are respectively fixed to the corresponding cover member fixing holes 98 of the caliper body 51C and fix corresponding protrusion portions 113C of the cover member 14C to the caliper body 51C (not shown).

The cover member 14C in a fixed state of being fixed to the caliper body 51C by the fixing members 131, the first cover portion 111 and the second cover portion 112 are disposed similarly to the first cover portion 111 and the second cover portion 112 of the first embodiment with respect to the end surface 65 of the caliper body 51C, the disc 11 (refer to FIG. 3), and the brake pad 18.

In the cover member 14C in this fixed state, the protrusion portions 113C extend in a direction in which they approach the brake pad 18 in the disc axial direction from the first cover portion 111. In addition, in the cover member 14C in this fixed state, the protrusion portions 113C extend perpendicularly to the radial reference plane and extend parallel to the disc axial direction.

In the cover member 14C in this fixed state, a gap between the end edge portion 121, which is the tip of the second cover portion 112 on the inward side in the disc radial direction, and the brake pad 18 in the disc axial direction is provided at a position farther away from the second cover portion 112 than the virtual line X4 drawn in a direction in which the cover member fixing holes 98 extend.

An extension line of the center axis of the fixing member 131 for retaining the cover member 14C in this fixed state, that is, the virtual line X4 of the center axis of the cover member fixing hole 98 of the caliper 13 intersects the second cover portion 112.

The cover member 14C in this fixed state has the protrusion portions 113C protruding toward the recessed portions 81 on a side facing the brake pad 18. The protrusion portions 113C are fixed to the caliper body 51C by the fixing members 131.

In the cover member 14C in this fixed state, a gap between the end edge portion 121, which is the tip of the second cover portion 112 on the inward side in the disc radial direction, and the brake pad 18 in the disc axial direction is smaller than the diameters of the screw portions of the screw shaft portions 133 of the fixing members 131, that is, the screw outer diameters.

In the cover member 14C in this fixed state, the second cover portion 112 extends toward the brake pad 18 in the disc axial direction from the first cover portion 111, and covers the fixing member insertion holes 125 and the cover member fixing holes 98 when viewed in the disc radial direction. Specifically, in the cover member 14C in this fixed state, when viewed from the inside in the disc radial direction, the second cover portion 112 covers the cover member fixing holes 98 in their entirety and covers a part of the fixing member insertion holes 125. In the cover member 14C in this fixed state, when viewed from the inside in the disc radial direction, the second cover portion 112 covers the insertion hole portions 126 in their entirety.

In the caliper 13C, the bottom surface portions 92C lie in the disc axial direction.

In the cover member 14C in this fixed state, when viewed from the inside in the disc radial direction, the second cover portion 112 covers at least a part of the tool engagement grooves 136 of the fixing members 131 (refer to FIG. 4). Specifically, in the cover member 14C in this fixed state, when viewed from the inside in the disc radial direction, the second cover portion 112 covers the tool engagement grooves 136 (refer to FIG. 4) including the center portions disposed on the center axes of the fixing members 131.

In the disc brake 10C of the fourth embodiment, the second cover portion 112 of the cover member 14C extends toward the brake pad 18 in the disc axial direction from the first cover portion 111, and covers the cover member fixing holes 98 engaged with the fixing members 131 when viewed from the inside in the disc radial direction. Thus, it becomes difficult for a tool to be inserted into the disc brake 10C through the gap between the cover member 14C and the brake pad 18 and engage with the fixing members 131. Therefore, the disc brake 10C is enabled to curb removal of the cover member 14C in a state of being attached to a vehicle.

In the disc brake 10C, a gap between the end edge portion 121, which is the tip of the second cover portion 112 on the inward side in the disc radial direction, and the brake pad 18 in the disc axial direction is provided at a position farther away from the second cover portion 112 than the virtual line X4 drawn in a direction in which the cover member fixing holes 98 extend. Thus, it becomes difficult for a tool to be inserted into the disc brake 10C through the gap between the cover member 14C and the brake pad 18 and engage with the fixing members 131. Therefore, the disc brake 10C is enabled to further curb removal of the cover member 14C in a state of being attached to a vehicle.

In the disc brake 10C, the cover member 14C has the protrusion portions 113C protruding toward the recessed portions 81 on a side facing the brake pad 18. Further, in the cover member 14C, the protrusion portions 113C are fixed to the caliper 13C by the fixing members 131. Thus, at the time of assembling the disc brake 10C, the cover member 14C can be easily attached to the caliper body 51C by the fixing members 131.

In the disc brake 10C, the bottom surface portions 92C of the caliper 13C are parallel to the disc axial direction. Thus, it is easy to perform machining when forming the cover member fixing holes 98 in the caliper 13C in the disc radial direction.

In the disc brake 10C, the second cover portion 112 of the cover member 14C extends toward the brake pad 18 in the disc axial direction from the first cover portion 111, and covers the cover member fixing holes 98 engaged with the fixing members 131 when viewed from the inside in the disc radial direction. Thus, it becomes difficult for a tool to be inserted into the disc brake 10C through the gap between the cover member 14C and the brake pad 18 and engage with the fixing members 131. Therefore, the disc brake 10C is enabled to curb removal of the cover member 14C in a state of being attached to a vehicle.

In the disc brake 10C of the fourth embodiment, in place of the fixing structure constituted of the cover member fixing holes 98, the fixing member insertion hole 125, and the fixing members 131 for the cover member 14C with respect to the caliper body 51C, a fixing structure constituted of the cover member fixing holes 98A, the fixing member insertion hole 125A, and the fixing members 131A of the second embodiment can also be employed.

### Fifth Embodiment

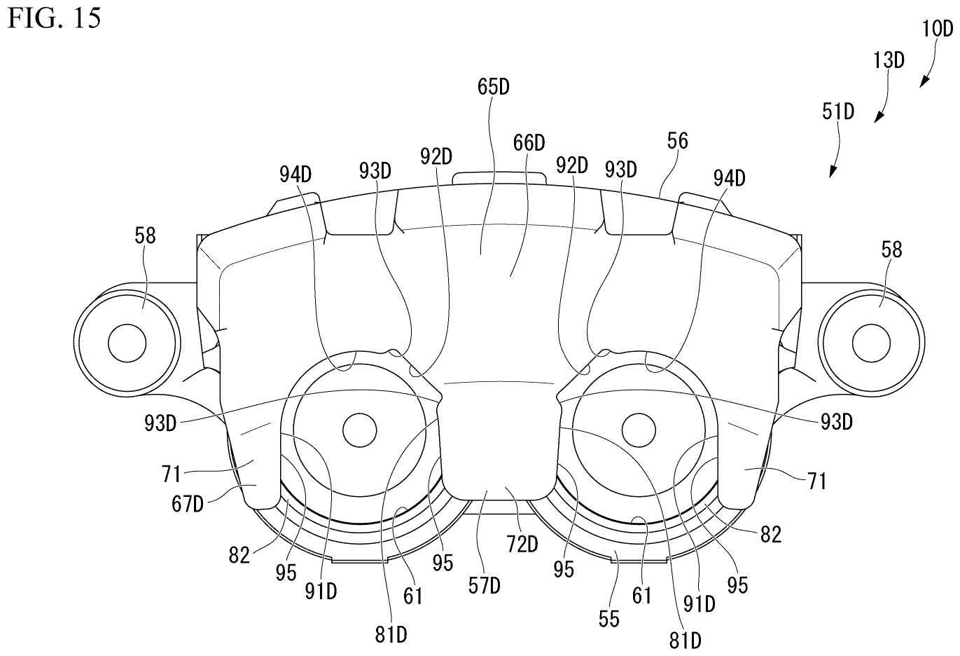

Next, a fifth embodiment will be described mainly with reference to FIGS. 15 to 18, focusing on parts different from those of the first embodiment. Parts common to those of the first embodiment will be expressed by the same names and the same reference signs.

In a disc brake 10D of the fifth embodiment, as shown in FIGS. 15 to 18, a caliper 13D which is partially different from the caliper 13 is used in place of the caliper 13. In the caliper 13D, a caliper body 51D which is partially different from the caliper body 51 is used in place of the caliper body 51. In the caliper body 51D, a facing portion 57D which is partially different from the facing portion 57 is formed in place of the facing portion 57. As shown in FIGS. 15 to 17, in the facing portion 57D, two recessed portions 81D which are partially different from the two recessed portions 81 are formed in place of the two recessed portions 81.

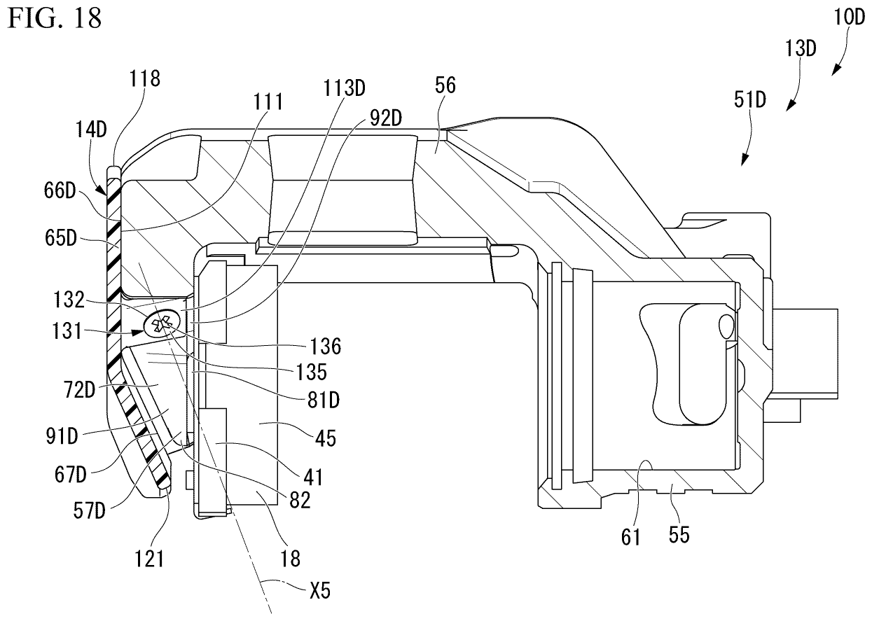

As shown in FIGS. 15 and 18, in the caliper body 51D, an end surface 65D on a side opposite to the cylinder portions 55 in the disc axial direction has a main surface portion 66D and an inclined surface portion 67D.

The main surface portion 66D is on the end surface 65D on the outward side in the disc radial direction. The main surface portion 66D has a planar shape extending perpendicularly to the disc axis.

The inclined surface portion 67D is on the end surface 65D on the inward side in the disc radial direction. The inclined surface portion 67D extends to the inward side in the disc radial direction from an end edge portion of the main surface portion 66D on the inward side in the disc radial direction.

When viewed in the disc circumferential direction, as shown in FIG. 18, the main surface portion 66D is inclined in a manner of being positioned on the cylinder portions 55 side in the disc axial direction as it goes toward the inward side in the disc radial direction.

In the caliper body 51D, the main surface portion 66D is formed by the bridge portion 56 and parts of the pair of outer claws 71 and an intermediate claw 72D on the outward side in the disc radial direction. In the caliper body 51D, the inclined surface portion 67D is formed in parts of the pair of outer claws 71 and the intermediate claw 72D on the inward side in the disc radial direction from the main surface portion 66D.

As shown in FIG. 15, in place of the intermediate claw 72, the facing portion 57D has the intermediate claw 72D (claw) which is partially different from the intermediate claw 72 at a position between the pair of outer claws 71 similar to those of the first embodiment in the disc circumferential direction. Similarly to the pair of outer claws 71, the intermediate claw 72D is on a side of the bridge portion 56 opposite to the cylinder portions 55 in the disc axial direction, extends to the inward side in the disc radial direction from the bridge portion 56, and is positioned on the outer side in the disc axial direction with respect to the disc 11 (refer to FIG. 3). In other words, similar to the pair of outer claws 71, the intermediate claw 72D is formed on the tip side of the bridge portion 56 in the extending direction from the cylinder portions 55. Similarly to the pair of outer claws 71, the intermediate claw 72D positionally overlaps the cylinder portions 55 in the disc circumferential direction and the disc radial direction and is disposed in a manner of facing the cylinder portions 55 in the disc axial direction. The intermediate claw 72D has a width in the disc circumferential direction wider than the width of each of the pair of outer claws 71 in the disc circumferential direction.

The one outer claw 71 of the pair of outer claws 71, the intermediate claw 72D, and the other outer claw 71 of the pair of outer claws 71 are disposed apart from each other in the disc circumferential direction. Accordingly, in the facing portion 57D, a part between the one outer claw 71 of the pair of outer claws 71 and the intermediate claw 72D adjacent thereto in the disc circumferential direction becomes the recessed portion 81D penetrating it in the disc axial direction and having a shape opening inward in the disc radial direction. In addition, in the facing portion 57D, a part between the intermediate claw 72D and the other outer claw 71 of the pair of outer claws 71 adjacent thereto in the disc circumferential direction becomes the recessed portion 81D penetrating it in the disc axial direction and having a shape opening inward in the disc radial direction. In other words, the recessed portions 81D are provided between the outer claws 71 and the intermediate claw 72D and have a shape recessed toward the outward side in the disc radial direction from the end portion of the facing portion 57D on the inward side in the disc radial direction. Similarly to those of the first embodiment, the recessed portions 81D have the opening portions 82 at their end portions on the inward side in the disc radial direction.

As described above, since the facing portion 57D have three claws, such as the pair of outer claws 71 and the intermediate claw 72D, a pair of, that is, two recessed portions 81D are provided. The two recessed portions 81D include one recessed portion 81D and the other recessed portion 81D. In the caliper body 51D, the recessed portions 81D are formed in a manner of respectively facing the pair of cylinder holes 61 in the disc axial direction. That is, the caliper body 51D is provided with the same number of recessed portions 81D as that of the cylinder holes 61. The two recessed portions 81D are positionally aligned with each other in the disc axial direction and the disc radial direction and are separated from each other in the disc circumferential direction.

The one recessed portion 81D provided between the one outer claw 71 and the intermediate claw 72D positionally overlaps the one cylinder hole 61 in the disc circumferential direction and the disc radial direction and faces it in the disc axial direction. This one recessed portion 81D is a part through which a tool for machining the inside of this one cylinder hole 61 that faces is inserted.

The other recessed portion 81D provided between the other outer claw 71 and the intermediate claw 72D positionally overlaps the other cylinder hole 61 in the disc circumferential direction and the disc radial direction and faces it in the disc axial direction. The other recessed portion 81D is a part through which a tool for machining the inside of the other cylinder hole 61 that faces is inserted.

In other words, in the facing portion 57D, the one recessed portion 81D is formed in a manner of opposing the one cylinder hole 61, and the other recessed portion 81D is formed in a manner of opposing the other cylinder hole 61. The caliper body 51D, that is, the caliper 13D including the caliper body 51D has the pair of recessed portions 81D.

These recessed portions 81D have a shape which is mirror symmetrical with respect to the radial reference plane.

These recessed portions 81D are provided side by side in the disc circumferential direction in a manner of being positionally aligned in the disc axial direction and the disc radial direction, and are positionally shifted in the disc circumferential direction. Since the two recessed portions 81D have a shape which is mirror symmetrical with respect to the radial reference plane, the one recessed portion 81D will be described herein as an example.

An inner circumferential surface 91D of the recessed portion 81D has a hole opening surface portion 92D, a pair of hole side wall surface portions 93D, arc-shaped surface portions 94D, and the pair of opening side wall surface portions 95 similar to those of the first embodiment.

The pair of hole side wall surface portions 93D include the hole side wall surface portion 93D on the outward side in the disc circumferential direction and the hole side wall surface portion 93D on the inward side in the disc circumferential direction. The pair of opening side wall surface portions 95 include the opening side wall surface portion 95 on the outward side in the disc circumferential direction and the opening side wall surface portion 95 on the inward side in the disc circumferential direction.

The hole opening surface portions 92D are closer to the intermediate claw 72D side than the center portions of the recessed portions 81D in the disc circumferential direction. In other words, the hole opening surface portions 92D are provided at positions other than the center portions of the recessed portions 81D in the disc circumferential direction. The hole opening surface portions 92D have a planar shape. The hole opening surface portions 92D extend in a manner of being inclined with respect to the radial reference line when viewed in the disc axial direction.

When viewed in the disc axial direction, the hole opening surface portions 92D are positioned on the inward side in the disc radial direction as it goes to the inward side in the disc circumferential direction. When viewed in the disc circumferential direction, the hole opening surface portions 92D extend in a manner of being positioned on the outward side in the disc radial direction as they approach the cylinder portions 55 in the disc axial direction.

Thus, the hole opening surface portions 92D are inclined with respect to the radial reference plane and extend in a manner of being positioned on the outward side in the disc radial direction as they approach the cylinder portions 55 in the disc axial direction.

Both the pair of hole side wall surface portions 93D have substantially a planar shape, are positionally aligned with each other in the disc axial direction, and are separated from each other in the disc circumferential direction. The hole side wall surface portion 93D on the outward side in the disc circumferential direction extends to the inward side in the disc radial direction and the outward side in the disc circumferential direction from the end edge portion of the hole opening surface portion 92D on the outward side in the disc circumferential direction. The hole side wall surface portion 93D on the inward side in the disc circumferential direction extends to the inward side in the disc radial direction and the outward side in the disc circumferential direction from the end edge portion of the hole opening surface portion 92D on the inward side in the disc circumferential direction. Both the pair of hole side wall surface portions 93D lie in the disc axial direction. A space between the pair of hole side wall surface portions 93D increases as it goes toward the inward side in the disc radial direction and the outward side in the disc circumferential direction. The pair of hole side wall surface portions 93D have a mirror symmetrical shape.

The arc-shaped surface portion 94D has a shape of a part on a cylinder surface. The arc-shaped surface portion 94D extends to the outward side in the disc circumferential direction from the end edge portion on a side of the hole side wall surface portion 93D on the outward side in the disc circumferential direction opposite to the hole opening surface portion 92D. This arc-shaped surface portion 94D is positioned slightly on the outward side in the disc radial direction toward the outward side in the disc circumferential direction and is then positioned on the inward side in the disc radial direction. This arc-shaped surface portion 94D forms a shape of a part on a cylinder surface having the center axis of the opposing cylinder hole 61 as its center axis. The arc-shaped surface portions 94D lie in the disc axial direction.

Both the pair of opening side wall surface portions 95 have substantially a planar shape, are positionally aligned with each other in the disc axial direction and the disc radial direction, and are separated from each other in the disc circumferential direction. The opening side wall surface portion 95 on the outward side in the disc circumferential direction extends inward in the disc radial direction from the end edge portion of the arc-shaped surface portion 94D on the outward side in the disc circumferential direction. This opening side wall surface portion 95 is positioned on the outward side in the disc circumferential direction as it goes inward in the disc radial direction. The opening side wall surface portion 95 on the inward side in the disc circumferential direction extends inward in the disc radial direction from the end edge portion of the hole side wall surface portion 93D of the pair of hole side wall surface portions 93D on the inward side in the disc circumferential direction on a side opposite to the hole opening surface portion 92D. This opening side wall surface portion 95 is positioned on the inward side in the disc circumferential direction as it goes inward in the disc radial direction. Both the pair of opening side wall surface portions 95 lie in the disc axial direction. A space between the pair of opening side wall surface portions 95 in the disc circumferential direction increases as it goes toward the inward side in the disc radial direction. The pair of opening side wall surface portions 95 have a mirror symmetrical shape.

The caliper body 51D is provided with two recessed portions 81D having the foregoing shape side by side in the disc circumferential direction. In the two recessed portions 81D, each of the hole opening surface portions 92D is disposed such that an obtuse angle is formed.

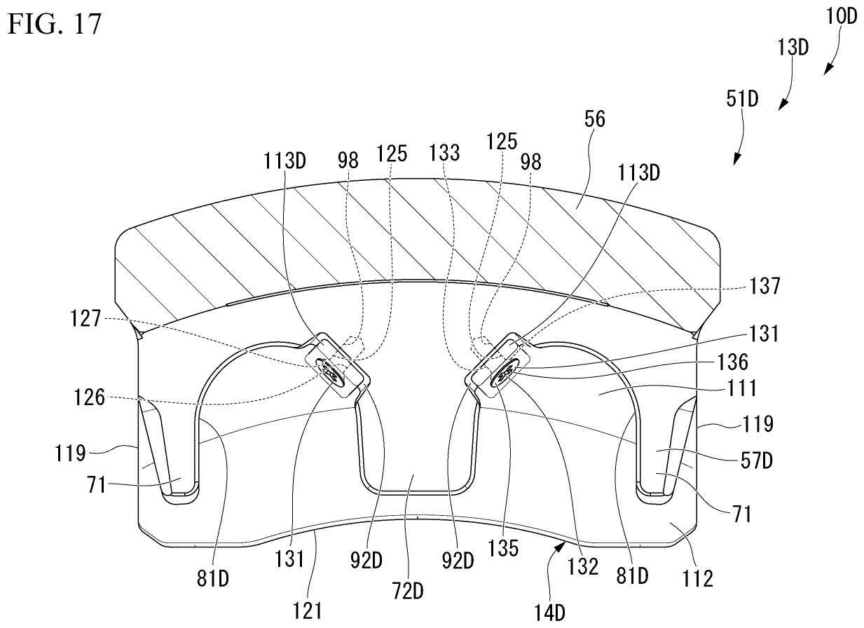

As shown in FIG. 17, the caliper body 51D has two cover member fixing holes 98 similar to those of the first embodiment. The two cover member fixing holes 98 include one cover member fixing hole 98 and the other cover member fixing hole 98. The one cover member fixing hole 98 is formed perpendicularly to the hole opening surface portion 92D at a position in the hole opening surface portion 92D of the one recessed portion 81D of the two recessed portions 81D. The other cover member fixing hole 98 is formed perpendicularly to the hole opening surface portion 92D at a position in the hole opening surface portion 92D of the other recessed portion 81D of the two recessed portions 81D.

These cover member fixing holes 98 have a shape which is mirror symmetrical with respect to the radial reference plane. These cover member fixing holes 98 are provided side by side in the disc circumferential direction in a manner of being positionally aligned in the disc axial direction and the disc radial direction, and are positionally shifted in the disc circumferential direction. Since the two cover member fixing holes 98 have a mirror symmetrical shape, the one cover member fixing hole 98 will be described herein as an example.

The cover member fixing holes 98 are formed in a manner of opening at center positions in the hole opening surface portion 92D in the disc circumferential direction and intermediate positions in the disc axial direction. Thus, the cover member fixing holes 98 extend in a manner of being inclined with respect to the radial reference line when viewed in the disc axial direction. The cover member fixing holes 98 approach the radial reference line as the depth increases when viewed in the disc axial direction. The cover member fixing holes 98 extend in a manner of approaching the cylinder portions 55 in the disc axial direction as the depth decreases when viewed in the disc circumferential direction. Thus, the cover member fixing holes 98 are provided in the inner circumferences of the recessed portions 81D and are formed in a manner of being inclined with respect to the disc radial direction. A virtual line X5 (shown in FIG. 18) drawn in a direction in which the cover member fixing holes 98 extend does not pass through the outer claws 71 and the intermediate claw 72D.

As shown in FIG. 17, in the caliper body 51D, two cover member fixing holes 98 having the foregoing constitution are provided side by side in the disc circumferential direction.

In the disc brake 10D, a cover member 14D which is partially different from the cover member 14 is used in place of the cover member 14. In the cover member 14D, two protrusion portions 113D which are partially different from the two protrusion portions 113 are formed in place of the two protrusion portions 113. The cover member 14D have a mirror symmetrical shape.

Both the two protrusion portions 113D have a plate shape protruding to one side of the first cover portion 111 in the thickness direction from the first cover portion 111. The two protrusion portions 113D protrude from the first cover portion 111 to the same side as that in a direction in which the second cover portion 112 is inclined. The two protrusion portions 113D are disposed in the first cover portion 111 with a space therebetween in a direction in which the end edge portion 121 extend. Both the two protrusion portions 113D extend in a manner of being inclined with respect to a direction in which the end edge portion 121 extend. Since the two protrusion portions 113D have a mirror symmetrical shape, the one protrusion portion 113D will be described herein as an example.

The one protrusion portion 113D is inclined with respect to a direction in which the end edge portion 121 extends in a manner of approaching the second cover portion 112 in a direction in which the pair of end edge portions 119 extend as they approach the other protrusion portion 113D in a direction in which the end edge portion 121 extends. The protrusion portions 113D are inclined with respect to the thickness direction of the first cover portion 111 in a manner of being separated from the second cover portion 112 in a direction in which the pair of end edge portions 119 extend as they are separated from the first cover portion 111 in the thickness direction of the first cover portion 111.

In the protrusion portions 113D, the fixing member insertion hole 125 similar to those of the first embodiment are formed perpendicularly to the thickness direction. Thus, the fixing member insertion hole 125 of the one protrusion portion 113D is inclined with respect to a direction in which the pair of end edge portions 119 extend in a manner of approaching the other protrusion portion 113D in a direction in which the end edge portion 121 extends as it is separated from the second cover portion 112 in a direction in which the pair of end edge portions 119 of the first cover portion 111 extend. The fixing member insertion hole 125 is inclined with respect to the first cover portion 111 in a manner of approaching the first cover portion 111 in the thickness direction of the first cover portion 111 as it is separated from the second cover portion 112 in a direction in which the pair of end edge portions 119 extend.

The second cover portion 112 extends from the first cover portion 111 to a position overlapping the fixing member insertion holes 125 in the thickness direction of the first cover portion 111. The second cover portion 112 overlaps the insertion hole portions 126 in their entirety in the thickness direction of the first cover portion 111 and overlaps a part on the first cover portion 111 side including the center axes of the interlock hole portions 127.

The cover member 14D is provided with the foregoing two protrusion portions 113D.

The cover member 14D is fixed to the caliper body 51D by the two fixing members 131.

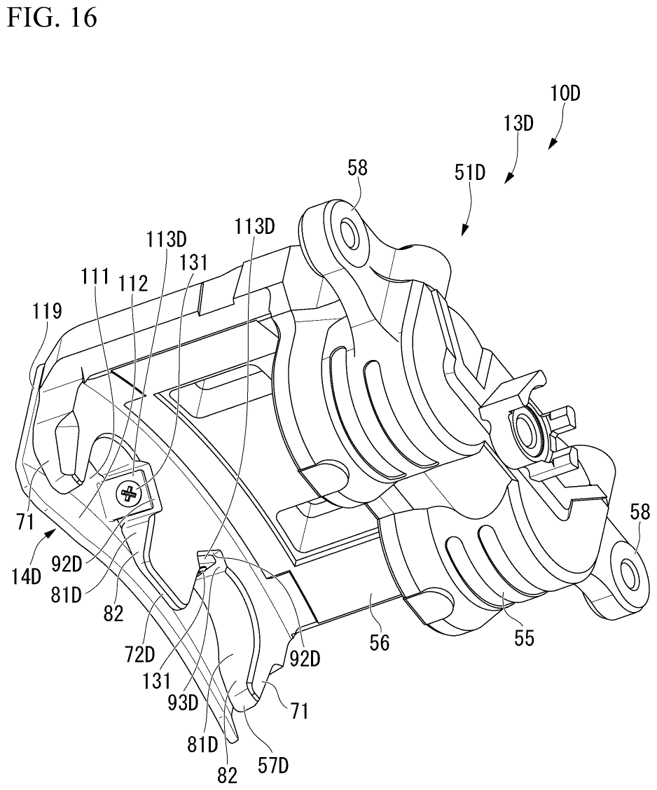

As shown in FIGS. 16 and 18, the cover member 14D is disposed on a side of the facing portion 57D of the caliper body 51D opposite to the cylinder portions 55 in the disc axial direction. At this time, as shown in FIG. 18, in the cover member 14D, the first cover portion 111 positionally overlaps the main surface portion 66D of the caliper body 51D in the disc radial direction and the disc circumferential direction and abuts it in the disc axial direction in a surface contact manner. In addition, at this time, in the cover member 14D, the second cover portion 112 positionally overlaps the inclined surface portion 67D of the caliper body 51D in the disc radial direction and the disc circumferential direction and is disposed in a manner of facing it in the disc axial direction. In addition, at this time, as shown in FIG. 17, in the cover member 14D, the one protrusion portion 113D of the pair of protrusion portions 113D abuts the one hole opening surface portion 92D of the pair of hole opening surface portions 92D of the caliper body 51D in a surface contact manner. In addition, at this time, in the cover member 14D, the other protrusion portion 113D of the pair of protrusion portions 113D abuts the other hole opening surface portion 92D of the pair of hole opening surface portions 92D of the caliper body 51D in a surface contact manner.

In this state, the one fixing member 131 of the pair of fixing members 131 is inserted through the fixing member insertion hole 125 of the one protrusion portion 113D of the pair of protrusion portions 113D of the cover member 14D in the screw shaft portions 133. Thereafter, this screw shaft portion 133 is screwed into the cover member fixing hole 98 opening in the one hole opening surface portion 92D of the pair of hole opening surface portions 92D of the caliper body 51D which this protrusion portion 113D abuts. Consequently, in this fixing member 131, the tapered end surface 137 thereof abuts the interlock hole portion 127 of this fixing member insertion hole 125 and presses and fixes this protrusion portion 113D to the caliper body 51D. In other words, the one protrusion portion 113D of the pair of protrusion portions 113D is clamped between one of the pair of hole opening surface portions 92D of the caliper body 51D and the end surface 137 of the one fixing member 131 of the pair of fixing members 131.

In this state, the other fixing member 131 of the pair of fixing members 131 is inserted through the fixing member insertion hole 125 of the other protrusion portion 113D of the pair of protrusion portions 113D of the cover member 14D in the screw shaft portion 133. Thereafter, this screw shaft portion 133 is screwed into the cover member fixing hole 98 opening in the other hole opening surface portion 92D of the pair of hole opening surface portions 92D of the caliper body 51D which this protrusion portion 113D abuts. Consequently, in this fixing member 131, the tapered end surface 137 thereof abuts the interlock hole portion 127 of this fixing member insertion hole 125 and presses and fixes this protrusion portion 113D to the caliper body 51D. In other words, the other protrusion portion 113D of the pair of protrusion portions 113D is clamped between the other of the pair of hole opening surface portions 92D of the caliper body 51D and the end surface 137 of the other fixing member 131 of the pair of fixing members 131.

In this manner, the cover member 14D is fixed to the caliper body 51D by the two fixing members 131. In other words, the cover member 14D is fixed to the caliper 13D by the fixing members 131 engaging with the cover member fixing holes 98. Moreover, in other words, the fixing members 131 fix the cover member 14D to the caliper 13D by being fastened to the cover member fixing holes 98.

As shown in FIG. 16, the cover member 14D in a fixed state of being fixed to the caliper body 51D by the two fixing members 131 covers the pair of outer claws 71, the intermediate claw 72D, and the pair of recessed portions 81D of the caliper body 51D from the side opposite to the cylinder portions 55 in the disc axial direction. In other words, as shown in FIG. 17, the cover member 14D is fixed to the caliper body 51D of the caliper 13D by the fixing members 131 engaging with the cover member fixing holes 98 and covers the recessed portions 81D in the disc axial direction.

As shown in FIG. 18, in the cover member 14D in this fixed state, the first cover portion 111 extends perpendicularly to the disc axis. In other words, the first cover portion 111 extends in the disc radial direction and the disc circumferential direction.

In the cover member 14D in this fixed state, the second cover portion 112 connected to the first cover portion 111 approaches the brake pad 18 in the disc axial direction as it goes toward the inward side in the disc radial direction. In other words, the second cover portion 112 is connected to the first cover portion 111 and extends such that a gap between the second cover portion 112 and the brake pad 18 decreases in the disc radial direction as it approaches the disc axis in the disc axial direction.

In the cover member 14D in this fixed state, the pair of protrusion portions 113D extend in a direction in which they approach the brake pad 18 in the disc axial direction from the first cover portion 111. In addition, in the cover member 14D in this fixed state, the pair of protrusion portions 113D are positioned on the outward side in the disc radial direction as they approach the brake pad 18 in the disc axial direction.

In the cover member 14D in this fixed state, a gap between the end edge portion 121, which is the tip of the second cover portion 112 on the inward side in the disc radial direction, and the brake pad 18 in the disc axial direction is provided at a position farther away from the brake pad 18 than the virtual line X5 drawn in a direction in which the cover member fixing holes 98 extend.

An extension line of the center axis of the fixing member 131 for retaining the cover member 14D in a fixed state, that is, the virtual line X5 of the center axis of the cover member fixing hole 98 of the caliper 13D intersects the brake pad 18.

The cover member 14D in this fixed state has the protrusion portions 113D protruding toward the recessed portions 81D on a side facing the brake pad 18. The protrusion portions 113D are fixed to the caliper body 51D by the fixing members 131.

In the cover member 14D in this fixed state, a gap between the end edge portion 121, which is the tip of the second cover portion 112 on the inward side in the disc radial direction, and the brake pad 18 in the disc axial direction is smaller than the diameters of the screw portions of the screw shaft portions 133 of the fixing members 131, that is, the screw outer diameters.

In the cover member 14D in this fixed state, the second cover portion 112 extends toward the brake pad 18 in the disc axial direction from the first cover portion 111, and covers the fixing member insertion holes 125 and the cover member fixing holes 98 when viewed in the disc radial direction. Specifically, in the cover member 14D in this fixed state, when viewed from the inside in the disc radial direction, the second cover portion 112 covers the cover member fixing holes 98 in their entirety and covers a part of the fixing member insertion holes 125. In the cover member 14D in this fixed state, when viewed from the inside in the disc radial direction, the second cover portion 112 covers the insertion hole portions 126 in their entirety.

In addition, in the caliper 13D, the hole opening surface portions 92D are inclined such that the distance to the disc axis increases as they approach the brake pad 18 in the disc axial direction.

In addition, in the cover member 14D in this fixed state, when viewed from the inside in the disc radial direction, the second cover portion 112 covers at least a part of the tool engagement grooves 136 of the fixing members 131. Specifically, in the cover member 14D in this fixed state, when viewed from the inside in the disc radial direction, the second cover portion 112 covers the tool engagement grooves 136 including the center portions disposed on the center axes of the fixing members 131.

In the disc brake 10D of the fifth embodiment, the cover member fixing holes 98 of the caliper 13D with which the fixing members 131 engage are formed in the inner circumferences of the recessed portions 81D in a manner of being inclined with respect to the disc radial direction. Thus, it is possible to make it difficult for a tool to engage with the fixing members 131 engaging with the cover member fixing holes 98. Therefore, the disc brake 10D is enabled to curb removal of the cover member 14D in a state of being attached to a vehicle.

In the disc brake 10D, the first cover portion 111 of the cover member 14D extends in the disc radial direction and the disc circumferential direction, and the second cover portion 112 connected to the first cover portion 111 extends such that the gap between the second cover portion 112 and the brake pad 18 decreases in the disc axial direction as it approaches the disc axis in the disc radial direction. Thus, it becomes difficult for a tool to be inserted into the disc brake 10D through the gap between the cover member 14D and the brake pad 18 and engage with the fixing members 131. Therefore, the disc brake 10D is enabled to further curb removal of the cover member 14D in a state of being attached to a vehicle.

In the disc brake 10D, a gap between the end edge portion 121, which is the tip of the second cover portion 112 on the inward side in the disc radial direction, and the brake pad 18 in the disc axial direction is provided at a position farther away from the brake pad 18 than the virtual line X5 drawn in a direction in which the cover member fixing holes 98 extend. Thus, it becomes difficult for a tool to be inserted into the disc brake 10D through the gap between the cover member 14D and the brake pad 18 and engage with the fixing members 131. Therefore, the disc brake 10D is enabled to further curb removal of the cover member 14D in a state of being attached to a vehicle.

In the disc brake 10D, a gap between the end edge portion 121 of the cover member 14D, which is the tip of the second cover portion 112 on the inward side in the disc radial direction, and the brake pad 18 in the disc axial direction is smaller than the diameters of the screw portions of the fixing members 131. Thus, it becomes difficult to insert a tool having a suitable size with a diameter equivalent to the diameters of the screw portions into the fixing members 131 through the gap between the end edge portion 121 of the cover member 14D and the brake pad 18. Therefore, the disc brake 10D is enabled to further curb removal of the cover member 14D in a state of being attached to a vehicle.

In the disc brake 10D, the hole opening surface portions 92D in which the cover member fixing holes 98 of the caliper 13D open are provided at positions other than the center portions of the recessed portions 81D in the disc circumferential direction. Thus, it is possible to make it difficult for a tool to engage with the fixing members 131 engaging with the cover member fixing holes 98. Therefore, the disc brake 10D is enabled to further curb removal of the cover member 14D in a state of being attached to a vehicle.

In the disc brake 10D, the hole opening surface portions 92D of the caliper 13D are inclined such that the distance to the disc axis increases as they approach the brake pad 18 in the disc axial direction. Thus, it is easy to perform machining when forming the cover member fixing holes 98 in the caliper 13D in a manner of being inclined with respect to the disc radial direction.

In the disc brake 10D, the second cover portion 112 of the cover member 14D extends toward the brake pad 18 in the disc axial direction from the first cover portion 111, and covers the cover member fixing holes 98 engaged with the fixing members 131 when viewed from the inside in the disc radial direction. Thus, it becomes difficult for a tool to be inserted into the disc brake 10D through the gap between the cover member 14D and the brake pad 18 and engage with the fixing members 131. Therefore, the disc brake 10D is enabled to curb removal of the cover member 14D in a state of being attached to a vehicle.

In the disc brake 10D of the fifth embodiment, in place of the fixing structure constituted of the cover member fixing holes 98, the fixing member insertion hole 125, and the fixing members 131 for the cover member 14D with respect to the caliper body 51D, a fixing structure constituted of the cover member fixing holes 98A, the fixing member insertion hole 125A, and the fixing members 131A of the second embodiment can also be employed.

### INDUSTRIAL APPLICABILITY

According to the foregoing disc brake, it is possible to curb removal of a cover member from the disc brake in a state of being attached to a vehicle.

### REFERENCE SIGNS LIST

10, 10A to 10D Disc brake
11 Disc
12 Attachment member
13, 13A to 13D Caliper
14, 14A to 14D Cover member
17, 18 Brake pad
55 Cylinder portion
56 Bridge portion
61 Cylinder hole
62 Piston
71 Outer claw (claw)
72, 72D Intermediate claw (claw)
81, 81B to 81D Recessed portion
82 Opening portion
92, 92B, 92C Bottom surface portion (recessed bottom surface portion)
92D Hole opening surface portion
98,98A Cover member fixing hole
111 First cover portion
112 Second cover portion
113, 113A to 113D Protrusion portion
131 Fixing member (screw member, flat head screw)
131A Fixing member (rivet member)
X1 to X5 Virtual line

1. A disc brake for braking a vehicle having a disc rotating together with a wheel, the disc brake comprising:
an attachment member attached to a non-rotation portion of the vehicle;
a caliper movably provided in the attachment member, the caliper pressing a pair of brake pads against the disc, wherein the caliper includes:
a cylinder portion having a cylinder hole in which a piston for moving one of the pair of brake pads is disposed,
a bridge portion extending from the cylinder portion across an outer circumferential surface of the disc,
a plurality of claws formed on an extension tip side of the bridge portion and disposed in a manner of facing the cylinder portion, and
a recessed portion provided between the plurality of claws, having an opening portion at an inner end in a radial direction with respect to a rotation axis of the disc, and formed in a manner of opposing the cylinder hole, and
having a cover member fixing hole formed in an inner circumference of the recessed portion in a manner of being inclined with respect to the radial direction; and
a cover member fixed to the caliper by a fixing member engaging with the cover member fixing hole and covering the recessed portion in a direction of the rotation axis.

2. The disc brake according to claim 1,
wherein the cover member includes
a first cover portion extending in the radial direction, and
a second cover portion connected to the first cover portion and extending such that a gap between the second cover portion and the closer brake pad of the pair of brake pads decreases in the direction of the rotation axis as the second cover portion approaches the rotation axis in the radial direction.

3. The disc brake according to claim 2,
wherein a gap between a tip of the second cover portion and the closer brake pad of the pair of brake pads in the direction of the rotation axis is provided at a position farther away from the closer brake pad of the pair of brake pads than a virtual line drawn in a direction in which the cover member fixing hole extends.

4. The disc brake according to claim 2,
wherein in the cover member, an angle formed by the first cover portion and the second cover portion on a side facing the closer brake pad of the pair of brake pads in the direction of the rotation axis is an obtuse angle.

5. The disc brake according to claim 2,
wherein the first cover portion has a longer length in the radial direction than the second cover portion.

6. The disc brake according to claim 2,
wherein the cover member has a protrusion portion protruding toward the recessed portion on a side facing the closer brake pad of the pair of brake pads, and the protrusion portion is fixed to the caliper by the fixing member.

7. The disc brake according to claim 2,
wherein the fixing member is a screw member fixing the cover member to the caliper by being fastened to the cover member fixing hole, and
a gap between a tip of the second cover portion and the closer brake pad of the pair of brake pads in the direction of the rotation axis is smaller than a diameter of a screw portion of the screw member.

8. The disc brake according to claim 1,
wherein the cover member has a first cover portion extending in the radial direction, and
the cover member fixing hole is inclined with respect to the radial direction toward the first cover portion.

9. The disc brake according to claim 1,
wherein the recessed portion of the caliper has a recessed bottom surface portion provided at a position facing the opening portion of the recessed portion in the radial direction and having the cover member fixing hole opening therein, and the recessed bottom surface portion is inclined such that a distance to the rotation axis increases as the recessed bottom surface portion approaches the closer brake pad of the pair of brake pads in the direction of the rotation axis.

10. The disc brake according to claim 1,
wherein the recessed portion of the caliper has a hole opening surface portion provided at a position other than a center portion of the recessed portion in a circumferential direction with respect to the rotation axis of the disc and having the cover member fixing hole opening therein, and the hole opening surface portion is inclined such that a distance to the rotation axis increases as the hole opening surface portion approaches the closer brake pad of the pair of brake pads in the direction of the rotation axis.

11. The disc brake according to claim 1,
wherein the fixing member is a screw member fixing the cover member to the caliper by being fastened to the cover member fixing hole.

12. The disc brake according to claim 11,
wherein the screw member is a flat head screw.

13. The disc brake according to claim 1,
wherein the fixing member is a rivet member fixing the cover member to the caliper by being crimped into the cover member fixing hole.

14. A disc brake for braking a vehicle having a disc rotating together with a wheel, the disc brake comprising:
an attachment member attached to a non-rotation portion of the vehicle;
a caliper movably provided in the attachment member, the caliper pressing a pair of brake pads against the disc, wherein the caliper includes:
a cylinder portion having a cylinder hole in which a piston for moving one of the pair of brake pads is disposed,
a bridge portion extending from the cylinder portion across an outer circumferential surface of the disc,
a plurality of claws formed on an extension tip side of the bridge portion and disposed in a manner of facing the cylinder portion, and
a recessed portion provided between the plurality of claws, having an opening portion at an inner end in a radial direction with respect to a rotation axis of the disc, and formed in a manner of opposing the cylinder hole, and
provided with a cover member fixing hole in an inner circumference of the recessed portion; and
a cover member fixed to the caliper by a fixing member engaging with the cover member fixing hole, the cover member covering the recessed portion in a direction of the rotation axis, wherein the cover member includes:
a first cover portion extending in the radial direction, and
a second cover portion connected to the first cover portion, extending in the direction of the rotation axis toward the closer brake pad of the pair of brake pads, and covering the cover member fixing hole when viewed in the radial direction.
